(19) United States
(12) Patent Application Publication
(10) Pub. No.: US 2024/0298169 A1
(43) Pub. Date: Sep. 5, 2024

(54) ARTIFICIAL INTELLIGENCE AI COMMUNICATION METHOD AND APPARATUS

(71) Applicant: HUAWEI TECHNOLOGIES CO., LTD., Shenzhen (CN)

(72) Inventors: Sihai WANG, Beijing (CN); Cheng QIN, Beijing (CN); Rui YANG, Beijing (CN)

(21) Appl. No.: 18/661,006

(22) Filed: May 10, 2024

Related U.S. Application Data
(63) Continuation of application No. PCT/CN2022/131952, filed on Nov. 15, 2022.

(30) Foreign Application Priority Data
Nov. 16, 2021 (CN) 202111357588.2
Dec. 3, 2021 (CN) 202111464756.8

(51) Int. Cl. H04W 8/24; H04L 41/16

(52) U.S. Cl. CPC H04W 8/24; H04L 41/16

(57) ABSTRACT

An artificial intelligence AI communication method. A first apparatus receives AI model information sent by a second apparatus. The AI model information includes M groups of AI model complexity information corresponding to M AI models. Each of the M groups of AI model complexity information is time and/or energy consumption of executing one of the M AI models in each of N reference AI execution environments, wherein M and N are positive integers. The first apparatus sends feedback information to the second apparatus.

### CROSS-REFERENCE TO RELATED APPLICATIONS

This application continuation of International Application No. PCT/CN2022/131952, filed on Nov. 15, 2022, which claims priority to Chinese Patent Application No. 202111357588.2, filed on Nov. 16, 2021 and Chinese Patent Application No. 202111464756.8, filed on Dec. 3, 2021. All of the aforementioned patent applications are hereby incorporated by reference in their entireties.

### BACKGROUND

An artificial intelligence (artificial intelligence, AI) technology is a branch of computer science, runs through a historical process of computer development, and is an important development direction of the information technology industry. With development of communication technologies, more applications are intelligentized through AI. Currently, the AI technology is introduced into a wireless communication system, and an AI module is gradually used to replace a function module in the wireless communication system. After the AI technology is introduced into the wireless communication system, a working mode is that a network device sends an AI model to a terminal device, and the terminal device receives the AI model from the network device and uses the AI model to perform wireless communication.

AI capabilities of different terminal devices are different. Therefore, the AI model delivered by the network device fails to be executed by the terminal device. Consequently, the AI model cannot be used to perform wireless communication.

### SUMMARY

At least one embodiment provides an artificial intelligence AI communication method and apparatus, to better apply an AI technology to a wireless communication system.

According to a first aspect, at least one embodiment provides an AI communication method. The method is performed by a first device, and the first device is a terminal device or a receiver of an AI model in a communication system. The method is implemented by using the following steps: The first device receives AI model information sent by a second device, where the AI model information includes M groups of AI model complexity information corresponding to M AI models, each of the M groups of AI model complexity information is time and/or energy consumption of executing one of the M AI models in each of N reference AI execution environments, and M and N are positive integers; and the first device sends feedback information to the second device.

In this implementation, the second device sends the AI model information to the first device, so that the first device is able to evaluate matching between an AI model and an AI capability of the first device, to ensure feasibility of communication between the first device and the second device by using the AI model.

In at least one embodiment, the feedback information is response information of the AI model information.

In at least one embodiment, the feedback information is used to request the second device to enable an AI communication mode: or the feedback information includes an evaluation result of at least one of the M AI models: or the feedback information is used to request to obtain at least one of the M AI models.

In at least one embodiment, after the first device sends the feedback information to the second device, the first device receives configuration information sent by the second device, where the configuration information indicates the first device to enable the AI communication mode, or the configuration information indicates at least one of the M AI models, or the configuration information indicates a configuration parameter of at least one of the M AI models, or the configuration information indicates a method for obtaining at least one of the M AI models.

In at least one embodiment, the at least one AI model includes a first AI model, and an evaluation result of the first AI model includes whether the first AI model matches the first device, or an evaluation result of the first AI model includes expected time and/or energy consumption of executing of the first AI model by the first device.

In at least one embodiment, before the first device receives the AI model information sent by the second device, the first device sends request information to the second device, where the request information is used to request the second device to send the AI model information to the first device.

In at least one embodiment, the M AI models include the first AI model, the N reference AI execution environments include a first reference AI execution environment, time of executing the first AI model in the first reference AI execution environment is a first time value, a first time level, or a first time range, and energy consumption of executing the first AI model in the first reference execution environment is a first energy consumption value, a first energy consumption level, or a first energy consumption range.

In at least one embodiment, the M AI models include the first AI model, the M groups of AI model complexity information include a first group of AI model complexity information corresponding to the first AI model, and the first group of AI model complexity information includes one or more of the following: an amount of input data used in response to the first AI model being executed in each of the N reference AI execution environments: numerical precision of the input data used in response to the first AI model being executed in each of the N reference AI execution environments: numerical precision of a weight of the first AI model; and operation precision of the first AI model obtained in response to the first AI model being executed in each of the N reference AI execution environments.

In at least one embodiment, the AI model information includes an upper limit of time used by the first device to execute each of the M AI models.

According to a second aspect, at least one embodiment provides an AI communication method. The method is performed by a second device, and the second device is a network device or a sender of an AI model in a communication system. The method is implemented by using the following steps: The second device obtains AI model information, where the AI model information includes M groups of AI model complexity information corresponding to M AI models, each of the M groups of AI model complexity information is time and/or energy consumption of executing one of the M AI models in each of N reference AI execution environments, and M and N are positive integers; and the second device sends the AI model information to a first device.

In at least one embodiment, after the second device sends the AI model information to the first device, the second device receives feedback information sent by the first device, where the feedback information requests the second device to enable an AI communication mode, or the feedback information includes an evaluation result of at least one of the M AI models, or the feedback information requests to obtain at least one of the M AI models.

In at least one embodiment, the feedback information is response information of the AI model information.

In at least one embodiment, after the second device receives the feedback information sent by the first device, the second device sends configuration information to the first device, where the configuration information indicates the first device to enable the AI communication mode, or the configuration information indicates at least one of the M AI models, or the configuration information indicates a configuration parameter of at least one of the M AI models, or the configuration information indicates a method for obtaining at least one of the M AI models.

In at least one embodiment, the at least one AI model includes a first AI model, and an evaluation result of the first AI model includes whether the first AI model matches the first device, or an evaluation result of the first AI model includes expected time and/or energy consumption of executing of the first AI model by the first device.

In at least one embodiment, before the second device sends the AI model information to the first device, the second device receives request information sent by the first device, where the request information is used to request the second device to send the AI model information to the first device.

In at least one embodiment, that the second device sends the AI model information to a first device includes: The second device periodically sends the AI model information to the first device: or in response to the first device accessing a network in which the second device is located, the second device sends the AI model information to the first device: or in response to the first device establishing a communication connection to the second device, the second device sends the AI model information to the first device: or in response to structures or computing amounts of the M AI models changing, the second device sends the AI model information to the first device.

In at least one embodiment, the M AI models include the first AI model, the N reference AI execution environments include a first reference AI execution environment, time of executing the first AI model in the first reference AI execution environment is a first time value, a first time level, or a first time range, and energy consumption of executing the first AI model in the first reference execution environment is a first energy consumption value, a first energy consumption level, or a first energy consumption range.

In at least one embodiment, the M AI models include the first AI model, the M groups of AI model complexity information include a first group of AI model complexity information corresponding to the first AI model, and the first group of AI model complexity information includes one or more of the following: an amount of input data used in response to the first AI model being executed in each of the N reference AI execution environments: numerical precision of the input data used in response to the first AI model being executed in each of the N reference AI execution environments: numerical precision of a weight of the first AI model; and operation precision of the first AI model obtained in response to the first AI model being executed in each of the N reference AI execution environments.

In at least one embodiment, the AI model information includes an upper limit of time used by the first device to execute each of the M AI models.

For beneficial effects of the second aspect, refer to the related description of the first aspect. Details are not described herein again.

According to a third aspect, at least one embodiment provides an AI communication method. The method is performed by a first device, and the first device is a terminal device or a receiver of an AI model in a communication system. The method is implemented by using the following steps: The first device obtains AI capability information, where the AI capability information includes a similarity between the first device and each of at least one reference AI execution environment; and the first device sends the AI capability information to a second device.

In this implementation, the first device sends the AI capability information to the second device, so that the second device evaluates matching between an AI model and an AI capability of the first device, to ensure feasibility of communication between the first device and the second device by using the AI model.

In at least one embodiment, after the first device sends the AI capability information to the second device, the first device receives configuration information sent by the second device, where the configuration information indicates the first device to enable an AI communication mode, or the configuration information indicates at least one AI model, or the configuration information indicates a configuration parameter of at least one AI model, or the configuration information indicates a method for obtaining at least one AI model.

In at least one embodiment, the configuration information is response information of the AI capability information.

In at least one embodiment, before the first device sends the AI capability information to the second device, the first device receives request information from the second device, where the request information is used to request the first device to send the AI capability information to the second device.

In at least one embodiment, that the first device sends the AI capability information to a second device includes: The first device periodically sends the AI capability information to the second device: or in response to the first device accessing a network in which the second device is located, the first device sends the AI capability information to the second device: or in response to the first device establishing a communication connection to the second device, the first device sends the AI capability information to the second device: or in response to a computing resource used by the first device to execute the AI model changing, the first device sends the AI capability information to the second device.

In at least one embodiment, similarity information includes a computing power similarity and/or an energy consumption similarity between the first device and each of the at least one reference AI execution environment.

In at least one embodiment, the AI capability information includes one or more of the following: an upper limit of time used by the first device to execute the AI model: an upper limit of energy consumption used by the first device to execute the AI model; and resource usage used by the first device to execute the AI model.

According to a fourth aspect, at least one embodiment provides an AI communication method. The method is performed by a second device, and the second device is a network device or a sender of an AI model in a communication system. The method is implemented by using the following steps: The second device receives AI capability information sent by a first device, where the AI capability information includes a similarity between the first device and each of at least one reference AI execution environment.

In at least one embodiment, after the second device receives the AI capability information sent by the first device, the second device sends configuration information to the first device, where the configuration information indicates the first device to enable an AI communication mode, or the configuration information indicates at least one AI model, or the configuration information indicates a configuration parameter of at least one AI model, or the configuration information indicates a method for obtaining at least one AI model.

In at least one embodiment, in response to the configuration information indicating at least one AI model, or the configuration information indicates a configuration parameter of at least one AI model, or the configuration information indicates a method for obtaining at least one AI model, before the second device sends the configuration information to the first device, the second device further determines the at least one AI model based on the AI capability information.

In at least one embodiment, the configuration information is response information of the AI capability information.

In at least one embodiment, before the second device receives the AI capability information sent by the first device, the second device sends request information to the first device, where the request information is used to request the first device to send the AI capability information to the second device.

In at least one embodiment, similarity information includes a computing power similarity and/or an energy consumption similarity between the first device and each of the at least one reference AI execution environment.

In at least one embodiment, the AI capability information includes one or more of the following: an upper limit of time used by the first device to execute the AI model; an upper limit of energy consumption used by the first device to execute the AI model; and resource usage used by the first device to execute the AI model.

For beneficial effects of the fourth aspect, refer to the related description of the third aspect. Details are not described herein again.

According to a fifth aspect, at least one embodiment further provides a communication apparatus. The communication apparatus is a terminal device, or the communication apparatus is a receive end device in a communication system. The communication apparatus implements functions of the first device according to any one of the first aspect or the third aspect. The function is implemented by hardware, or is implemented by hardware executing corresponding software. The hardware or the software includes one or more modules corresponding to the foregoing function.

In at least one embodiment, a structure of the communication apparatus includes a transceiver unit and a processing unit. These units perform corresponding functions of the first device according to any one of the first aspect or the third aspect. For details, refer to detailed descriptions in the method examples. Details are not described herein again.

In at least one embodiment, a structure of the communication apparatus includes a transceiver and a processor, and optionally, further includes a memory. The transceiver is configured to receive and send data, and is configured to communicate and interact with another device in a communication system. The processor is configured to support the communication apparatus in performing corresponding functions of the first device according to any one of the first aspect or the third aspect. The memory is coupled to the processor, and stores program instructions and data that are used for the communication apparatus.

According to a sixth aspect, at least one embodiment further provides a communication apparatus. The communication apparatus is a network device, or the communication apparatus is a transmit end device in a communication system. The communication apparatus implements functions of the second device according to any one of the second aspect or the fourth aspect. The function is implemented by hardware, or is implemented by hardware executing corresponding software. The hardware or the software includes one or more modules corresponding to the foregoing function.

In at least one embodiment, a structure of the communication apparatus includes a transceiver unit and a processing unit. These units perform corresponding functions of the second device according to any one of the second aspect or the fourth aspect. For details, refer to detailed descriptions in the method examples. Details are not described herein again.

In at least one embodiment, a structure of the communication apparatus includes a transceiver and a processor, and optionally, further includes a memory. The transceiver is configured to receive and send data, and is configured to communicate and interact with another device in a communication system. The processor is configured to support the communication apparatus in performing corresponding functions of the second device according to any one of the second aspect or the fourth aspect. The memory is coupled to the processor, and stores program instructions and data that are used for the communication apparatus.

According to a seventh aspect, at least one embodiment provides a communication system, which includes the first device and the second device mentioned above.

According to an eighth aspect, at least one embodiment provides a computer-readable storage medium, where the computer-readable storage medium stores program instructions, and in response to the program instructions being run on a computer, the computer is enabled to perform the method according to any one of the first aspect to the fourth aspect. For example, the computer-readable storage medium is any usable medium accessible to the computer. The following provides an example but does not impose a limitation. The computer-readable medium includes a non-transient computer-readable medium, a random access memory (random access memory, RAM), a read-only memory (read-only memory, ROM), an electrically erasable programmable read-only memory (electrically EPROM, EEPROM), a CD-ROM or another optical disc storage, a magnetic disk storage medium or another magnetic storage device, or any other medium that is used to carry or store expected program code in a form of instructions or a data structure and is accessed by the computer.

According to a ninth aspect, at least one embodiment provides a computer program product that includes computer program code or instructions. In response to the computer program product running on a computer, the computer is enabled to implement the method according to any one of the first aspect to the fourth aspect.

According to a tenth aspect, at least one embodiment further provides a chip, including a processor, where the processor is coupled to a memory, and is configured to read and execute program instructions stored in the memory, so that the chip implements the method according to any one of the first aspect to the fourth aspect.

For each aspect of the fifth aspect to the tenth aspect and technical effects that is achieved by each aspect, refer to descriptions of technical effects that is achieved by each solution in the first aspect to the fourth aspect. Details are not described herein again.

### BRIEF DESCRIPTION OF DRAWINGS

FIG. 1 is a schematic diagram of an architecture of a communication system according to at least one embodiment;

FIG. 2 is a schematic diagram of a process in which a network device and a terminal device perform wireless communication by using an AI model according to at least one embodiment;

FIG. 3 is a schematic flowchart 1 of an AI communication method according to at least one embodiment;

FIG. 4 is a schematic flowchart 1 in which a terminal device evaluates a matching degree between an AI capability and an AI model according to at least one embodiment;

FIG. 5A and FIG. 5B are a schematic diagram of AI execution environment similarity definition according to at least one embodiment;

FIG. 6 is a schematic flowchart 2 of an AI communication method according to at least one embodiment;

FIG. 7 is a schematic flowchart in which a network device evaluates a matching degree between an AI capability and an AI model according to at least one embodiment;

FIG. 8 is a schematic flowchart 2 in which a terminal device evaluates a matching degree between an AI capability and an AI model according to at least one embodiment;

FIG. 9A and FIG. 9B are a schematic diagram of AI model similarity definition according to at least one embodiment;

FIG. 10 is a diagram of an architecture of a reference AI execution environment list and a schematic flowchart of maintenance and synchronization of the reference AI execution environment list according to at least one embodiment;

FIG. 11 is a schematic flowchart of maintenance and synchronization of a reference AI execution environment list according to at least one embodiment;

FIG. 12 is a schematic diagram 1 of a structure of a communication apparatus according to at least one embodiment; and

FIG. 13 is a schematic diagram 2 of a structure of a communication apparatus according to at least one embodiment.

### DESCRIPTION OF EMBODIMENTS

The following further describes the technical solutions in at least one embodiment in detail with reference to the accompanying drawings.

The technical solutions provided in at least one embodiment are applied to various communication systems, for example, a fifth generation (5th generation, 5G) or new radio (new radio, NR) system, a long term evolution (long term evolution, LTE) system, an LTE frequency division duplex (frequency division duplex, FDD) system, and an LTE time division duplex (time division duplex, TDD) system. The technical solutions provided in at least one embodiment are also applied to a future communication system, for example, a 6th generation mobile communication system. The technical solutions provided in at least one embodiment are further applied to device-to-device (device to device, D2D) communication, vehicle-to-everything (vehicle-to-everything, V2X) communication, machine-to-machine (machine to machine, M2M) communication, machine type communication (machine type communication, MTC), an internet of things (internet of things, IoT) communication system, or another communication system.

Embodiments described herein provide an artificial intelligence AI communication method and apparatus. The method and the apparatus in at least one embodiment are based on a same technical concept. Because problem-resolving principles of the method and the apparatus are similar, mutual reference is made to implementations of the apparatus and the method, and repeated parts are not described.

In the descriptions of embodiment described herein, terms such as “first” and “second” are only for distinction and description, but cannot be understood as indicating or implying relative importance, or as indicating or implying a sequence.

In the descriptions of embodiment described herein, “at least one (type)” refers to one or more (types), and “a plurality of (types)” refers to two or more than two (types).

In the descriptions of embodiment described herein, unless otherwise specified, “/” means “or”, for example, A/B means “A or B”: “and/or” used herein is only used to describe an association relationship between associated objects, and indicates that three relationships exist. For example, “A and/or B” indicate the following: Only A exists, both A and B exist, and only B exists. In addition, in the descriptions of at least one embodiment, “a plurality of” means two or more. To describe the technical solutions in at least one embodiment more clearly, the following describes in detail, with reference to the accompanying drawings, the downlink scheduling method and the apparatus provided in at least one embodiment.

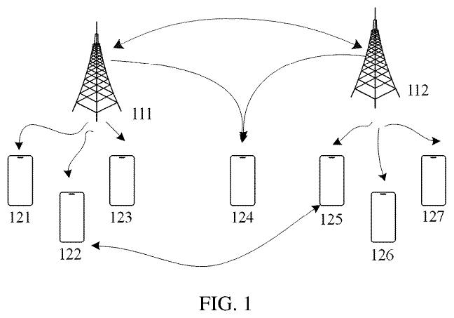

FIG. 1 is a schematic diagram of a wireless communication system applicable to at least one embodiment. As shown in FIG. 1, the wireless communication system includes at least one network device, for example, a network device 111 and a network device 112 shown in FIG. 1, and the wireless communication system further includes at least one terminal device, for example, a terminal device 121, a terminal device 122, a terminal device 123, a terminal device 124, a terminal device 125, a terminal device 126, and a terminal device 127 shown in FIG. 1. A plurality of antennas is configured for both the network device and the terminal device, and the network device and the terminal device communicate with each other by using a multi-antenna technology.

In response to the network device communicating with the terminal device, the network device manages one or more cells, and one cell has an integer quantity of terminal devices. A cell is understood as a region within coverage of a wireless signal of a network device.

At least one embodiment is used in a scenario in which a network device communicates with a terminal device. For example, the network device 111 communicates with the terminal device 121, the terminal device 122, and the terminal device 123. For another example, the network device 111 and the network device 112 communicates with the terminal device 124. At least one embodiment is further used in a scenario in which a terminal device communicates with another terminal device. For example, the terminal device 122 communicates with the terminal device 125. At least one embodiment is further used in a scenario in which a network device communicates with another network device. For example, the network device 111 communicates with the network device 112.

FIG. 1 is merely a simplified schematic diagram of an example for ease of understanding. At least one embodiment is not limited thereto. At least one embodiment is applicable to any communication scenario in which a transmit end device communicates with a receive end device.

The terminal device in at least one embodiment is also referred to as user equipment (user equipment, UE), an access terminal, a subscriber unit, a subscriber station, a mobile station, a remote station, a remote terminal, a mobile device, a user terminal, a terminal, a wireless communication device, a user agent, or a user apparatus.

The terminal device is a device that provides voice/data for a user, for example, a handheld device having a wireless connection function or a vehicle-mounted device. Currently, some examples of the terminal are a mobile phone (mobile phone), a tablet computer, a notebook computer, a palmtop computer, a mobile internet device (mobile internet device, MID), a wearable device, a virtual reality (virtual reality, VR) device, an augmented reality (augmented reality, AR) device, a wireless terminal in industrial control (industrial control), a wireless terminal in self-driving (self-driving), a wireless terminal in remote medical surgery (remote medical surgery), a wireless terminal in a smart grid (smart grid), a wireless terminal in transportation safety (transportation safety), a wireless terminal in a smart city (smart city), a wireless terminal in a smart home (smart home), a cellular phone, a cordless phone, a session initiation protocol (session initiation protocol, SIP) phone, a wireless local loop (wireless local loop, WLL) station, a personal digital assistant (personal digital assistant, PDA), a handheld device having a wireless communication function, a computing device or another processing device connected to a wireless modem, a wearable device, a terminal device in a 5G network, or a terminal device in a future evolved public land mobile communication network (public land mobile network, PLMN). This is not limited in at least one embodiment.

As an example instead of a limitation, in at least one embodiment, the terminal device is alternatively a wearable device. The wearable device is also referred to as a wearable intelligent device, and is a general term of a wearable device that is intelligently designed and developed for daily wear by using a wearable technology, for example, glasses, gloves, a watch, clothing, and shoes. The wearable device is a portable device that is directly worn on a body or integrated into clothes or an accessory of a user. The wearable device is not merely a hardware device, but is used to implement a powerful function through software support, data exchange, and cloud interaction. In a broad sense, intelligent wearable devices include full-featured and large-size devices that implement complete or partial functions without depending on smartphones, for example, smart watches or smart glasses, and devices that dedicated to only one type of application and are used together with other devices such as smartphones, such as various smart bands or smart jewelry used for monitoring physical signs.

In at least one embodiment, an apparatus configured to implement functions of the terminal device is a terminal device, or is an apparatus, for example, a chip system or a ship, that supports the terminal device in implementing the function. The apparatus is mounted in the terminal device. In at least one embodiment, the chip system includes a chip, or includes a chip and another discrete component.

The network device in at least one embodiment is a device configured to communicate with a terminal device. The network device is also referred to as an access network device or a radio access network device. For example, the network device is a base station. The network device in at least one embodiment is a radio access network (radio access network, RAN) node (or device) that connects a terminal device to a wireless network. The base station covers following various names in a broad sense, or is replaced with the following names, for example, a NodeB (NodeB), an evolved NodeB (evolved NodeB, eNB), a next generation NodeB (next generation NodeB, gNB), a relay station, an access point, a transmission and reception point (transmission and reception point, TRP), a transmission point (transmission point, TP), a master station, a secondary station, a multi-standard radio (multi-standard radio, MSR) node, a home base station, a network controller, an access node, a wireless node, an access point (AP), a transmission node, a transceiver node, a baseband unit (BBU), a remote radio unit (remote radio unit, RRU), an active antenna unit (active antenna unit, AAU), a remote radio head (remote radio head, RRH), a central unit (central unit, CU), a distributed unit (distributed unit, DU), or a positioning node. The base station is a macro base station, a micro base station, a relay node, a donor node, an analogue, or a combination thereof. The base station is alternatively a communication module, a modem, or a chip that is disposed in the foregoing device or apparatus. The base station is alternatively a mobile switching center, a device that bears a base station function in D2D, V2X, and M2M communication, a network side device in a 6G network, a device that bears a base station function in a future communication system, or the like. The base station supports networks of a same access technology or different access technologies. A specific technology and a specific device form that are used by the network device are not limited in at least one embodiment.

The base station is fixed or mobile. For example, a helicopter or an uncrewed aerial vehicle is configured as a mobile base station, and one or more cells move based on a location of the mobile base station. In other examples, a helicopter or an uncrewed aerial vehicle is configured as a device for communicating with another base station.

In some deployments, the network device mentioned in at least one embodiment is a CU, or a DU, or a device including a CU and a DU, or a device including a control plane CU node (a central unit-control plane (central unit-control plane, CU-CP)), a user plane CU node (a central unit-user plane (central unit-user plane, CU-UP)), and a DU node.

The network device and the terminal device is deployed on the land, including an indoor device, an outdoor device, a handheld device, or a vehicle-mounted device: is deployed on the water: or is deployed on an airplane, a balloon, and a satellite in the air. Scenarios in which the network device and the terminal device are located are not limited in at least one embodiment.

Artificial intelligence AI technologies are combined with wireless air interfaces to improve wireless network performance. An example is AI-based channel evaluation and signal detection. The signal detection is a process of extracting a received signal including interference noise from a wireless channel. The channel evaluation is a process of evaluating a model parameter of an assumed channel model from a received signal. Another example is an AI-based end-to-end communication link design. Another example is an AI-based channel state information (channel state information, CSI) feedback solution. To be specific, CSI is encoded by using a neural network, and the CSI is fed back to a network device.

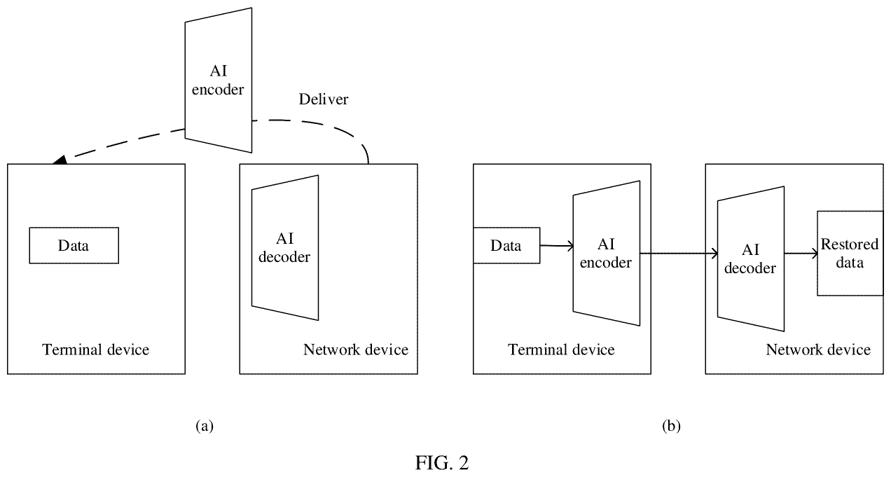

The AI-based channel state information (channel state information, CSI) feedback solution is used as an example to describe a process in which a network device and a terminal device perform wireless communication by using an AI model. As shown in (a) in FIG. 2, an AI encoder and a corresponding AI decoder is deployed in the network device. The network device sends or deliver the AI encoder to the terminal device, or indicate the terminal device to obtain the AI encoder, so that the terminal device subsequently performs CSI encoding by using the AI encoder. As shown in (b) in FIG. 2, the terminal device encodes the CSI by using the AI encoder, and send encoded information to the network device. Then, the network device decodes the information encoded by the terminal device by using the AI decoder, to obtain restored information. The AI encoder is alternatively understood as an AI model used for information encoding, and the AI decoder is alternatively understood as an AI model used for information decoding.

There are various AI models. Different AI models are used in different application scenarios. Generally, an AI model is implemented based on a neural network (neural network) model. The neural network model is a mathematical computing model that imitates a behavior feature of a human brain neural network and performs distributed parallel information processing. Some complex neural network models include a large quantity of parameters or a large amount of computing, but a capability (for example, a computing capability, a storage capability, or energy) of the terminal device is limited. Therefore, before performing AI communication between the network device and the terminal device, an AI capability of the terminal device supports execution (or referred to as running and processing) of the AI model sent by the network device. For example, a storage capability of the terminal device accommodates the AI model, a computing capability of the terminal device supports the AI model to complete computing within a predetermined time, and operating power consumption (or referred to as energy power consumption) of executing the AI model by the terminal device falls within an expected acceptable range.

Generally, an upper limit of computing delay tᵢ of the AI model (namely, an upper limit of AI model inference completion time) is known. Therefore, in a solution, matching between the AI model and the AI capability of the terminal device is evaluated by comparing the computing capability C_{UE} of the terminal device with computing complexity C_{M} of the AI model. In response to C_{M}/C_{UE}+tₜₕ≤tᵢ, the AI model completes computing within a predetermined delay, that is, the AI model complexity matches the computing capability of the terminal device. Otherwise, the AI model complexity does not match the computing capability of the terminal device. The computing capability C_{UE} of the terminal device is in a unit of floating-point operations per second (floating-point operations per second, FLOPS), the computing complexity C_{M} of the AI model is in a unit of floating-point operations (floating-point operations, FLOP), and tₜₕ is a margin that is configured in advance.

However, internal structures of AI models for a same purpose vary greatly. In actual computing, computing efficiency of AI models of different structures vary greatly due to different hardware computing rates, data scheduling delays, and the like. In addition, because a large amount of software conversion and optimization is used between an AI model and a hardware computing resource, different software conversion and optimization methods also bring different computing efficiency. In addition, different AI computing hardware implementations of the terminal device also bring different AI model computing efficiency. Therefore, factors such as an AI model structure design, software environment, and a hardware implementation leads to a hundreds-fold difference in computing efficiency, and evaluating actual matching between the AI model and the AI capability of the terminal device only by configuring the margin tₜₕ is difficult. For example, in response to a value of tₜₕ being too large, computing power resources is wasted: or in response to a value of tₜₕ being too small, execution of the AI model fails to be completed within the upper limit of delay limit. In addition, the value of tₜₕ is different in response to the AI model structure, the software environment, and the hardware implementation are different.

In another solution, terminal hardware information, for example, a simulator of a terminal device, is configured on a matching server. After obtaining detailed information about an AI model and a computing delay, the matching server obtains an accurate evaluation result of matching between AI model complexity and an AI capability of the terminal device. However, in this solution, the matching server and a corresponding interaction protocol is to be introduced. Therefore, a network structure and an interaction procedure are complex, and costs and an evaluation delay are increased.

Based on this, at least one embodiment provides an AI communication method and apparatus, to evaluate matching between AI model complexity and an AI capability of a device, and ensure feasibility of performing a communication service by using an AI model.

At least one embodiment is applied to a scenario in which any two devices (a first device and a second device) in a communication system communicate with each other. The first device has an execution (computing) environment for executing the AI model, and is ready to obtain the AI model from the second device and use the AI model. An AI capability of the first device indicates the execution environment, for example, includes a computing power, a storage capability, or an energy support capability of the first device. The second device has the AI model, and is ready to send the AI model to the first device for use. For example, the first device is the terminal device 121, the terminal device 122, or the terminal device 123 in FIG. 1, and the second device is the network device 111 in FIG. 1. For another example, the first device is the terminal device 122 in FIG. 1, and the second device is the terminal device 125 in FIG. 1. For another example, the first device is the network device 111 in FIG. 1, and the second device is the network device 112 in FIG. 1.

In embodiments shown below, interaction between a network device and a terminal device is used as an example to describe in detail the method provided in at least one embodiment, for ease of understanding and description.

The method and related apparatus provided in at least one embodiment are described below in detail with reference to the accompanying drawings. a presentation sequence of at least one embodiment merely represents a sequence of the embodiments, but does not represent superiority or inferiority of the technical solutions provided in the embodiments.

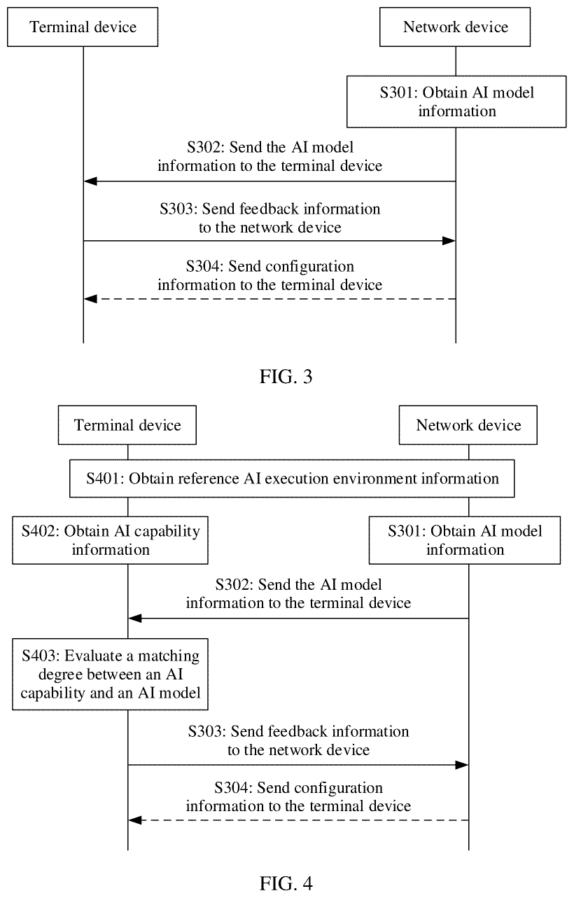

Based on the foregoing descriptions, at least one embodiment provides an AI communication method, which is applicable to the communication system shown in FIG. 1. As shown in FIG. 3, the method includes but is not limited to the following steps.

S301: A network device obtains AI model information. The AI model information indicates complexity information of each of M AI models.

For example, the AI model information includes M groups of AI model complexity information corresponding to the M AI models. Each of the M groups of AI model complexity information is time (or referred to as time consumption) and/or energy consumption of executing one of the M AI models in each of N reference AI execution environments, and M and N are positive integers.

For example, in response to M=3 and N=5, the AI model complexity information includes three groups of AI model complexity information (a first group of AI model complexity information, a second group of AI model complexity information, and a third group of AI model complexity information) corresponding to three AI models (P1, P2, and P3). The first group of AI model complexity information is time and/or energy consumption of executing the AI model P1 in five reference AI execution environments, the second group of AI model complexity information is time and/or energy consumption of executing the AI model P2 in the five reference AI execution environments, and the third group of AI model complexity information is time and/or energy consumption of executing the AI model P3 in the five reference AI execution environments.

Specifically, the reference AI execution environment is standardized in advance or formulated offline, and is disclosed to the network device and a terminal device.

Executing the AI model in the reference AI execution environment is replaced with a description that the AI model is executed in the reference AI execution environment. Executing the AI model in the reference AI execution environment is alternatively understood as that the AI model performs an inference or training operation in the reference AI execution environment. For example, the AI model is a neural network model. A common neural network model includes a ResNet series, a MobileNet series, a Transformer series, and the like.

Optionally, the time and/or energy consumption of executing the AI model in the AI execution environment is expressed by using an actual value, an approximate value, a level (for example, low/medium/high, or 1/2/3/4), or a range. Specifically, the M AI models includes a first AI model, the N reference AI execution environments includes a first reference AI execution environment, time of executing the first AI model in the first reference AI execution environment is a first time value, a first time level, or a first time range, and energy consumption of executing the first AI model in the first reference AI execution environment is a first energy consumption value, a first energy consumption level, or a first energy consumption range.

In at least one embodiment, the network device independently executes the M AI models in the reference AI environment, and obtain the AI model information through local computing. Optionally, the M AI models is prestored by the network device, or the M AI models is obtained by the network device from a third-party device, or the M AI models is generated by the network device. In at least one embodiment, the network device obtains the AI model information from a third-party device or a network device server. Optionally, the network device does not obtain the M AI models. In at least one embodiment, the network device is configured to obtain the AI model information during delivery or software upgrade. Optionally, the network device does not obtain the M AI models.

S302: The network device sends the AI model information to the terminal device. Correspondingly, the terminal device receives the AI model information sent by the network device.

Optionally, the AI model information sent by the network device includes an amount of input data used by the network device (or the third-party device, or the simulator, or the network device server) to execute the M AI models in each of the N reference AI execution environments. Optionally, the AI model information sent by the network device alternatively includes an amount of input data used for executing each of the M AI models in each reference AI execution environment. The amount of input data is also referred to as a quantity of samples. Generally, during model training, a batch (batch) of samples is executed at a time. A size of the batch of samples determines a quantity of samples for one training. Different computing efficiency is obtained in response to different amounts of input data being used.

The neural network includes a neuron. The neuron is an operation unit that uses xₛ and an intercept of 1 as input data. An output of the operation unit is as follows: h_{W,b}(x)=f(W^{T}x)=f(Σₛ₌₁ⁿWₛxₛ+b), where s=1, 2, . . . , n, n is a natural number, Wₛ is a weight of xₛ, and b is an offset of the neuron (which is also considered as a weight). Numerical precision of the input data and the weight affects the computing efficiency of the terminal device. The numerical precision is, for example, int8 (8-bit integer), int16 (16-bit integer), float16 (16-bit floating point), or the like. The numerical precision is alternatively equivalently represented as multiplication and addition operation precision. The operation precision also affects the computing efficiency of the terminal device. The operation precision is, for example, int8, int16, float16, or the like.

Optionally, the AI model complexity information sent by the network device further includes at least one of the following: numerical precision of the input data used by the network device (or the third-party device, or the simulator, or the network device server) to execute the M AI models in each of the N reference AI execution environments: numerical precision of a weight (or referred to as a weight value or a coefficient) of each of the M AI models: a total computing amount of each of the M AI models: a total quantity of layers of each of the M AI models; and operation precision of executing, by the network device (or the third-party device, or the simulator, or the network device server), the M AI models in each of the N reference AI execution environments.

For example, the M AI models includes the first AI model P1, the M groups of AI model complexity information include the first group of AI model complexity information corresponding to the first AI model P1, and the first group of AI model complexity information includes one or more of the following: an amount of input data used in response to the first AI model being executed in each of the N reference AI execution environments: numerical precision of the input data used in response to the first AI model being executed in each of the N reference AI execution environments: numerical precision of a weight of the first AI model; and operation precision of the first AI model obtained in response to the first AI model being executed in each of the N reference AI execution environments.

Time budget information for executing the AI model varies in different application scenarios. Further, the AI model information further includes an upper limit of time the network device expects (or wants or requires) the terminal device to take to complete execution of the AI model, namely, a period of time within which the terminal device is to complete execution of the AI model. the upper limit of time is also referred to as an upper time limit, maximum time, or a maximum time limit.

In an implementation, the AI model information includes an upper limit of time for executing each of the M AI models by the terminal device. In other words, the network device separately configures the upper time limit for each AI model. In another implementation, at least one of the M AI models uses (or share) a same upper limit of time. In other words, the network device configures the same upper limit of time for the at least one of the M AI models. Optionally, the M AI models uses a same upper limit of time. In this case, the network device is to configure only one upper limit of time.

Information included in the AI model information is included in same signaling, or is included in different signaling.

In response to the information included in the AI model information being in same signaling, the network device sends the AI model information to the terminal device at a time. For example, the network device sends first information to the terminal device, where the first information includes or indicate the AI model information, or the first information is the AI model information.

In response to the information included in the AI model information being in different signaling, the network device sends the AI model information to the network device at one or more times. Specifically, the following is included.

Example 1: The network device sends different complexity information such as time and/or energy consumption for executing the AI model in the reference AI execution environment, an amount of input data, and precision of the input data to the terminal device at one or more times. For example, the network device sends the first information to the terminal device, where the first information includes or indicates the time and/or energy consumption for executing the AI model in the reference AI execution environment. The network device sends second information to the terminal device, where the second information includes or indicates the amount of input data used for executing the AI model in the reference AI execution environment. The AI model information includes the first information and the second information.

Example 2: The network device sends the AI model information to the terminal device at one or more times. For example, the network device sends first information to the terminal device, where the first information includes or indicates complexity information such as time and/or energy consumption for executing the AI model in the reference AI execution environment, an amount of input data, and precision of the input data. The network device sends second information to the terminal device, where the second information includes or indicates updated complexity information. The AI model information includes the first information and the second information.

S303: The terminal device sends feedback information to the network device. Correspondingly, the network device receives the feedback information sent by the terminal device. In an embodiment, the feedback information is response information of the AI model information.

For example, the feedback information meets one or more of the following: The feedback information is used to request the network device to enable an AI communication mode: or the feedback information includes or indicate an evaluation result of at least one of the MAI models: or the feedback information is used to request to obtain at least one of the M AI models.

For example, the at least one AI model includes the first AI model, and an evaluation result of the first AI model includes or indicate whether the first AI model matches the AI capability of the terminal device, or an evaluation result of the first AI model includes or indicate expected time and/or energy consumption of executing the first AI model by the terminal device. Optionally, in response to the first AI model not matching the AI capability of the terminal device, the evaluation result of the first AI model includes a reason why the AI model does not match the AI capability, and the like.

In an implementation, as shown in FIG. 3, after step S303, that is, after the terminal device sends the feedback information to the network device, the method further includes the following steps.

S304: The network device sends configuration information to the terminal device. Correspondingly, the terminal device receives the configuration information sent by the network device. In an embodiment, the configuration information is response information of the feedback information.

Specifically, the configuration information meets one or more of the following: The configuration information indicates the terminal device to enable the AI communication mode. Further, AI communication is performed between the terminal device and the network device. Alternatively, the configuration information indicates at least one of the M AI models. Further, AI communication is performed between the terminal device and the network device by using the at least one AI model. Alternatively, the configuration information indicates a configuration parameter of at least one of the M AI models. Alternatively, the configuration information indicates a method for obtaining at least one of the M AI models. For example, the configuration information indicates a download address or an obtaining address of the at least one AI model. The at least one AI model is determined based on the feedback information.

In response to the configuration information indicating the method for obtaining the at least one AI model, specifically, the network device indicates the download address or the obtaining address of the at least one AI model. As described above, the M AI models is prestored in another device (for example, a third device). In this case, the network device indicates the terminal device to obtain the at least one AI model from the third device.

After receiving the feedback information sent by the terminal device, the network device alternatively makes no response.

In an implementation, specific triggering manners in which the network device sends the AI model information to the terminal device includes the following manners.

Manner 1: Before step S302, that is, before the network device sends the AI model information to the terminal device, the method further includes: The terminal device sends request information (or referred to as query information) to the network device, where the request information is used to request the network device to send the AI model information to the terminal device.

Manner 2: The network device periodically sends the AI model information to the terminal device. Alternatively, the network device sends the AI model information to the terminal device based on a predefined time interval or predefined specific time.

Manner 3: In response to the terminal device accessing a network in which the network device is located, the network device sends the AI model information to the terminal device. “In response to the terminal device accessing the network in which the network device is located” is alternatively described as “after the terminal device accesses the network in which the network device is located”, or “within specific time after the terminal device accesses the network in which the network device is located”. In addition, that the terminal device accesses the network in which the network device is located is alternatively understood as that the terminal device establishes a communication connection to the network device.

Manner 4: In response to a structure or a computing amount of the AI model changing, the network device sends the AI model information to the terminal device. In an implementation, in response to a structure or a computing amount of at least one of the M AI models changing, the network device sends, to the terminal device, the AI model complexity information corresponding to the M AI models. In another implementation, in response to structures or computing amounts of M1 AI models in the M AI models changing, the network device sends, to the terminal device, AI model complexity information corresponding to the M1 AI models, where M1 is a positive integer not greater than M. The network device sends only changed AI model complexity information to the terminal device, so that signaling overheads are reduced. Similarly, “when a structure or a computing amount of the AI model changes” is alternatively described as “after a structure or a computing amount of the AI model changes”, or “within specific time after a structure or a computing amount of the AI model changes”. Details are not described herein again.

In the foregoing implementations, after the network device sends the M groups of AI model complexity information corresponding to the M AI models to the terminal device, the terminal device evaluates and determine matching between the M AI models and the AI capability of the terminal device, so that simplicity, efficiency, and accuracy of an evaluation result is able to be improved, and AI communication is able to be better performed.

In the foregoing embodiments, before step S303, that is, before the terminal device sends the feedback information to the network device, the method further includes: The terminal device determines the feedback information based on the AI model information received in step S302. The following describes, by using specific embodiments, an example of a method for determining feedback information by a terminal device by evaluating M AI models and an AI capability of the terminal device.

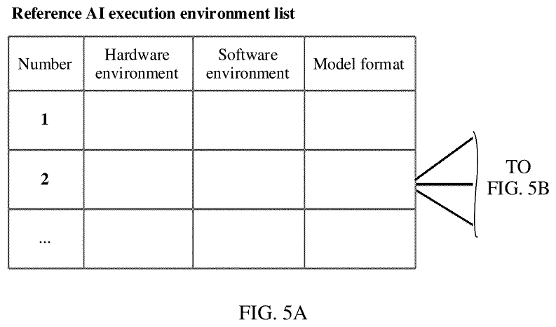

FIG. 4 is an example of a flowchart of a method in which a terminal device evaluates a matching degree between an AI capability and an AI model. As shown in FIG. 4, before a network device obtains AI model information, optionally, in step S401, the network device and the terminal device obtains reference AI execution environment information.

As described above, the reference AI execution environment information is standardized in advance or formulated offline, and is disclosed to the network device and the terminal device.

For example, the reference AI execution environment information is standardized in advance or formulated offline with reference to a reference AI execution environment list (or table). The reference AI execution environment list includes names, numbers, or indexes of K reference AI execution environments, and description parameters of the K reference AI execution environments. The description parameter of the reference AI execution environment includes a hardware environment (for example, a CPU type, a CPU dominant frequency, a mainboard model, a memory, or a specific model of an entire hardware system), a software environment (for example, an operating system or a deep learning framework), a model format, and the like. The reference AI execution environment list is disclosed to the network device and the terminal device in advance. Specifically, in step S301, the N reference AI execution environments for executing the M AI models is N reference AI execution environments in the K reference AI execution environments, where K is a positive integer, and N is a positive integer not greater than K.

In step S301, in response to the network device not obtaining the AI model information through local computing, the network device is able to not obtain the reference AI execution environment information. In other words, the network device may not perform step S401.

S402: The terminal device obtains AI capability information of the terminal device.

The terminal device is also an AI execution environment. The AI capability information of the terminal device is represented or defined by using a similarity between the terminal device and the reference AI execution environment. Optionally, the AI capability information of the terminal device is similarity information between the terminal device and the reference AI execution environment. The similarity information includes a computing power similarity and/or an energy consumption similarity. Each type of similarity information further includes two indicators: a capability ratio and an efficiency similarity. For example, the computing power similarity includes a computing power ratio and a computing efficiency similarity. The energy consumption similarity includes an energy consumption ratio and an energy consumption efficiency similarity.

In an implementation, the terminal device obtains the similarity information through local computing. In another implementation, a process of calculating the similarity information is alternatively completed in a device whose AI capability is the same as or similar to that of the terminal device, a simulator that truly reflects the AI capability of the terminal device, or a terminal device server. Specifically, an error of a computing result obtained in a device or a simulator whose AI capability is the same as or similar to that of the terminal device does not exceed an expected value. In this case, the terminal device obtains the AI capability information from the device, the simulator, or the terminal device server. In still another implementation, the similarity between the terminal device and the at least one reference AI execution environment is configured before delivery. In step S402, in response to the terminal device not obtaining the similarity information (that is, the AI capability information) through local computing, the terminal device is able to not obtain the reference AI execution environment information. In other words, the terminal device does not perform step S401.

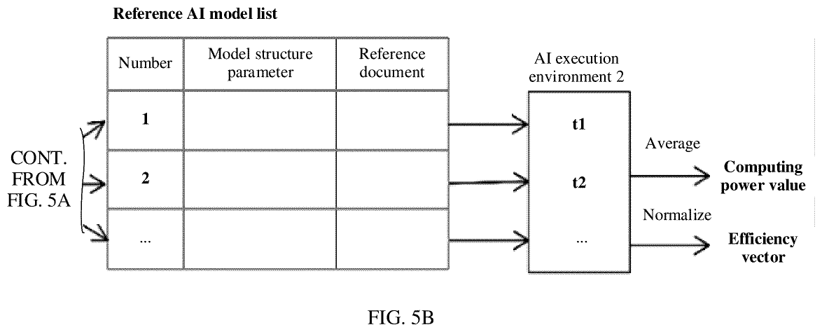

For a specific AI execution environment, a computing power characteristic and/or an energy consumption characteristic of the AI execution environment includes a capability value and an efficiency vector. The computing power characteristic is used as an example. As shown in FIG. 5A and FIG. 5B, an AI execution environment 2 in the reference AI execution environment list is used as an example. A computing method for the computing power characteristic is as follows: First, a reference AI model list is formulated. L1 reference AI models in the reference AI model list are executed (or trained and inferred) in the AI execution environment 2 one by one, to obtain execution time vectors including L1 execution completion time corresponding to the L1 reference AI models. A capability value C of the computing power (a computing power value) of the AI execution environment 2 is obtained by averaging the vectors, and an efficiency vector E of the computing power of the AI execution environment 2 is obtained by performing normalization processing on the vectors. Optionally, data processing is performed on the execution time vectors before or after the computing power value is obtained through averaging and/or the efficiency vector is obtained through normalization. For example, each execution time in the execution time vectors is divided by a total computing amount of a reference AI model corresponding to the execution time before the computing power value is obtained through averaging and/or the efficiency vector is obtained through normalization.

For example, the reference AI model list is standardized in advance or formulated offline, or is formulated and mastered only by the terminal device. The reference AI model list includes names, numbers, or indexes of L reference AI models, and structure description parameters of the L reference AI models. The structure description parameters of the L reference AI models are alternatively provided by referring to a reference document or a link. Based on the reference AI model list, the network device and the terminal device uniformly understand the network structures of the L reference AI models. Optionally, a specific weight coefficient value (weight value) of each AI model is not defined, is predefined, or is a random number. Specifically, the L1 reference AI models executed in the AI execution environment 2 is L1 reference AI models in the L reference AI models, where L is a positive integer, and L1 is a positive integer not greater than L.

According to the foregoing method, computing power characteristic information of the terminal device and the reference AI execution environment is obtained. Further, computing power similarity information between the AI execution environments is obtained by using the computing power ratio r and the computing efficiency similarity s between the AI execution environments. Specifically, in at least one embodiment of a method, a computing power ratio between any two AI execution environments is r=C1/C2 and an efficiency similarity between any two AI execution environments is s=norm[sim( [symbol] )], where C1 and C2 are respectively computing power values of the two AI execution environments, [symbol] and [symbol] are efficiency vectors of computing power of the two AI execution environments, sim is a similarity function between two vectors, for example, a cosine similarity function, a Euclidean distance computing function, or a standardized Euclidean distance function, and norm is a [0, 1] normalization computing function, that is, an input value of the normalization computing function is normalized to a range of [0, 1]. For example, in response to sim being used for cosine similarity computing and a result value range being [−1, 1], the normalization function

$$norm ( x ) = \frac{x + 1}{2} .$$

In this process, data processing is also performed.

In the foregoing method, the computing power similarity between the AI execution environments is defined by referring to the execution completion time of the AI model in the AI execution environment. Similarly, the energy consumption similarity between the AI execution environments is also defined by referring to the energy consumption of executing the AI model in the AI execution environment. Details are not described herein again.

S403: The terminal device evaluates a matching degree between the AI capability and the AI model.

After step S302, that is, after the network device sends the AI model information to the terminal device, the terminal device evaluates, based on the AI model information received in step S302 and the AI capability information (that is, the similarity information between the terminal device and the reference AI execution environment) of the terminal device obtained in step S402, matching between the AI capability of the terminal device and the M AI models, that is, expected performance of executing the M AI models in the terminal device, such as completion time, and energy consumption.

For example, in response to N=3, that is, in response to there being three reference AI execution environments, similarity information between the terminal device and the three reference AI execution environments is obtained by using the method in step S402. Computing power ratios between the terminal device and the three reference AI execution environments are r1, r2, and r3 respectively, which is alternatively represented as r(i), where i=1/2/3. Similarities of computing efficiency between the terminal device and the three reference AI execution environments are s1, s2, and s3 respectively, which is alternatively represented as s(i), where i=1/2/3. In step S302, the terminal device obtains time of executing the M AI models in the three reference AI execution environments. A first AI model in the M AI models is used as an example. The terminal device obtains time of executing the first AI model in the three reference AI execution environments, which are respectively t1, t2, and t3, and is alternatively represented as t(i), where i=1/2/3. Further, the terminal device obtains, by using the following two computing methods, expected completion time of executing the first AI model in the terminal device.

Computing method 1: weighted averaging. Specifically, the expected completion time of the first AI model in the terminal device is (t1*s1*r1+t2*s2*r2+t3*s3*r3)/(s1+2+s3)+Δt, where Δt is a time margin. Alternatively, the expected completion time of the first AI model in the terminal device is (t1*s1*r1+t2*s2*r2+t3*s3*r3)*(1+Δx)/(s1+s2+s3), where Δx is a margin proportion.

Computing method 2: optimal selection. Specifically, i=argmax(s(1), s(2), s(3)), and the expected completion time is t(i)*r(i)+Δt, where Δt is a time margin. Alternatively, the expected completion time is t(i)*r(i)*(1+Δx), where Δx is a margin proportion. Optionally, both Δt and Δx is related to s(i), for example, Δt and/or Δx is a constant divided by s(i), that is, a smaller s(i) indicates a larger margin of Δt and Δx.

In addition, in the foregoing computing process, in response to the AI capability information of the terminal device being obtained based on all AI computing resources of the terminal device, and the terminal device using only a part of the AI computing resources to execute the first AI model, corresponding conversion is to be performed. A conversion method is to divide the expected completion time obtained through computing in step S403 by a proportion of the part of AI computing resources to all AI computing resources, to obtain converted expected completion time.

According to the foregoing method, the terminal device obtains the expected completion time of executing the M AI models in the terminal device. Similarly, the terminal device further obtains expected energy consumption of executing the M AI models in the terminal device.

The foregoing description is an example of a method in which the terminal device evaluates the matching degree between the AI capability and the AI model. In some other embodiments, the terminal device alternatively performs evaluation by using another method. This is not limited in at least one embodiment.

Based on the expected completion time and/or the expected energy consumption of the M AI models that are obtained through the foregoing evaluation, and the upper limit of time used for executing the AI model that is sent by the network device and/or the upper limit of energy consumption used for executing the AI model that is locally determined by the terminal device, the terminal device determines whether the M AI models match the AI capability of the terminal device. For example, in response to the expected completion time of the first AI model in the M models does not exceed a time budget of the terminal device, and/or the expected energy consumption does not exceed an energy consumption limit of the terminal device, the terminal device determines that the first AI model matches the AI capability of the terminal device. The time budget of the terminal device is time budget information that is sent by the network device and that is used by the terminal device to execute the AI model, or is a local time budget of the terminal device. The energy consumption limit of the terminal device is a local energy consumption limit of the terminal device.

Further, the terminal device sends the feedback information to the network device. For example, in step S303, the feedback information indicates at least one AI model. Specifically, the terminal device selects at least one AI model from models that match the AI capability of the terminal device, and apply, based on the feedback information, for the network device to send the AI model. A rule for selecting the AI model by the terminal device is shortest expected completion time, least expected energy consumption, or a random rule.

It should be noted that in the embodiment shown in FIG. 4, for specific implementation processes of steps S301, S302, S303, and S304, refer to related descriptions in the embodiment shown in FIG. 3. Details are not described herein again.

In the foregoing embodiment, after the network device transfers complexity of a to-be-delivered AI model to the terminal device, the terminal device evaluates matching between the to-be-delivered AI model and the AI capability of the terminal device more conveniently, efficiently, and accurately, and further determine whether to request to start the AI model or request to deliver the AI model. This improves accuracy and efficiency of evaluating, by the terminal device, the matching degree between the AI capability and the AI model.

At least one embodiment further provides an AI communication method, which is applicable to the communication system shown in FIG. 1. As shown in FIG. 6, the method includes but is not limited to the following steps.

S601: A terminal device obtains AI capability information, where the AI capability information includes similarity information between the terminal device and each of at least one reference AI execution environment.

For example, in response to a quantity of the at least one reference AI execution environment being 3 (refer to an AI execution environment 1, an AI execution environment 2, and an AI execution environment 3), the AI capability information includes: similarity information between the terminal device and the reference AI execution environment 1, similarity information between the terminal device and the reference AI execution environment 2, and similarity information between the terminal device and the reference AI execution environment 3.

For example, reference AI execution environment information is standardized in advance or formulated offline, and is disclosed to a network device and the terminal device. For example, the at least one reference AI execution environment is in a reference AI execution environment list. For specific content of the reference AI execution environment list, refer to the foregoing descriptions.

Specifically, the similarity information between the terminal device and the reference AI execution environment includes a computing power similarity and/or an energy consumption similarity. Each type of similarity information further includes two indicators: a capability ratio and an efficiency similarity. For example, the computing power similarity includes a computing power ratio and a computing efficiency similarity. The energy consumption similarity includes an energy consumption ratio and an energy consumption efficiency similarity. For a specific example of calculating the similarity information between the terminal device and the reference AI execution environment, refer to related descriptions in step S402 shown in FIG. 4. Details are not described herein again.

Optionally, the similarity between the terminal device and the at least one reference AI execution environment is represented by using an actual value, an approximate value, a level, or a range. For example, the similarity between the terminal device and the reference AI execution environment 1 is a first similarity value, a first similarity level, or a first similarity range.

In an implementation, the terminal device obtains the similarity information through local computing. In another implementation, a process of calculating the similarity information is alternatively completed in a device whose AI capability is the same as or similar to that of the terminal device, a simulator that truly reflects the AI capability of the terminal device, or a terminal device server. Specifically, an error of a computing result obtained in a device or a simulator whose AI capability is the same as or similar to that of the terminal device does not exceed an expected value. In this case, the terminal device obtains the AI capability information from the another device, the simulator, or the terminal device server. In still another implementation, the similarity between the terminal device and the at least one reference AI execution environment is configured before delivery.

S602: The terminal device sends the AI capability information to the network device. Correspondingly, the network device receives the AI capability information sent by the terminal device.

In an implementation, as shown in FIG. 6, after step S602, that is, after the terminal device sends the AI capability information to the network device, the method further includes the following steps.

S603: The network device sends configuration information to the terminal device. Correspondingly, the terminal device receives the configuration information sent by the network device. In an embodiment, the configuration information is response information of the AI capability information.

Specifically, the configuration information meets one or more of the following: The configuration information indicates the terminal device to enable an AI mode. Further, AI communication is performed between the terminal device and the network device. Alternatively, the configuration information indicates at least one AI model. Further, AI communication is performed between the terminal device and the network device by using the at least one AI model. Alternatively, the configuration information indicates a configuration parameter of the at least one AI model. Alternatively, the configuration information indicates a method for obtaining at least one AI model. For example, the configuration information indicates a download address or an obtaining address of the at least one AI model. The at least one AI model is determined based on the AI capability information.

After receiving the AI capability information sent by the terminal device, the network device alternatively makes no response.

In an implementation, specific triggering manners in which the terminal device sends the AI capability information to the network device includes the following manners.

Manner 1: The network device sends request information (or referred to as indication information) to the terminal device. Correspondingly, the terminal device receives the request information sent by the network device. The request information is used to request the terminal device to send (or report) the AI capability information to the network device.

Manner 2: The terminal device periodically sends the AI capability information to the network device. Alternatively, the terminal device sends the AI capability information to the network device based on a predefined time interval or predefined specific time.

Manner 3: In response to the terminal device accessing a network in which the network device is located, the terminal device sends the AI capability information to the network device. “In response to the terminal device accessing the network in which the network device is located” is alternatively described as “after the terminal device accesses the network in which the network device is located”, or “within specific time after the terminal device accesses the network in which the network device is located”. In addition, that the terminal device accesses the network in which the network device is located is alternatively understood as that the terminal device establishes a communication connection to the network device.

Manner 4: In response to a computing resource that is used by the terminal device to execute the AI model changing (for example, increases or decreases), or a proportion of a computing resource that is used by the terminal device to execute the AI model changes, the terminal device sends the AI capability information to the network device. Similarly, “when a computing resource that is used by the terminal device to execute the AI model changes” is alternatively described as “after a computing resource that is used by the terminal device to execute the AI model changes”, or “within specific time after a computing resource that is used by the terminal device to execute the AI model changes”. Details are not described herein again.

In response to the terminal device being in different application scenarios, complexity of operations that is to be completed varies, and a power consumption/energy usage, a time usage, a used resource usage, and the like that is to be accepted (or tolerated) by the terminal device for executing the AI model are also different. In other words, in different application scenarios, a maximum time usage, a maximum energy consumption usage, or a resource usage of the terminal device for executing the AI model are different. The maximum time is a period of time within which the terminal device should complete executing the AI model. The maximum energy consumption usage is maximum energy that is allowed to be consumed by the terminal device after executing the AI model. The resource usage is a maximum proportion of a resource that is allowed to be used by the terminal device to execute the AI model to an available resource of the terminal device, or a hardware resource configuration that is used by the terminal device to execute the AI model. The execution of the AI model by the terminal device refers to a process in which the terminal device executes the AI model in the AI communication mode. A type of the AI model executed by the terminal device is not limited.

Further, in response to the terminal device being in different application scenarios, the terminal device sends the AI capability information to the network device. The AI capability information includes at least one of an upper limit of time, an upper limit of energy consumption, and resource usage that are used by the terminal device to execute the AI model. The upper limit of time is referred to as an upper time limit, maximum time, or a maximum time usage. The upper limit of energy consumption is referred to as an upper energy consumption limit, maximum energy consumption, or a maximum energy consumption usage. The resource usage is, for example, a hardware resource configuration or an upper limit of resource proportion that is to be used by the terminal device. The upper limit of resource proportion is also referred to as an upper resource proportion limit, a maximum resource proportion, or a maximum resource proportion usage. Optionally, before the terminal device sends the AI capability to the network device, the network device further sends query information to the terminal device, where the query information instructs the terminal device to report one or more of the upper limit of time, the upper limit of energy consumption, and the resource usage that are used to execute the AI model.

In response to an application scenario of the terminal device changing, the terminal device reports, to the network device, at least one of the upper limit of time, the upper limit of energy consumption, or the resource usage information that is used by the terminal device to execute the AI model, to notify the network device of at least one of the time budget, the energy consumption limit, and a resource proportion consumption limit for executing the AI model by the network device. In this case, information about the upper limit of time, information about the upper limit of energy consumption, or the resource usage information and the information reported in step S602 is carried in different signaling.

In the foregoing implementation, the terminal device reports the AI capability information of the terminal device, so that the network device evaluates, based on the AI capability information, matching between the AI capability of the terminal device and the AI model, and further determine whether to enable the AI communication mode or deliver an appropriate AI model, so that simplicity, efficiency, and accuracy of an evaluation result of the network device is able to be improved, and AI communication is able to be better performed.

In the foregoing embodiment, after the terminal device sends the AI capability information of the terminal device to the network device, the network device evaluates matching between the AI capability of the terminal device and the AI model, and determine the configuration information.

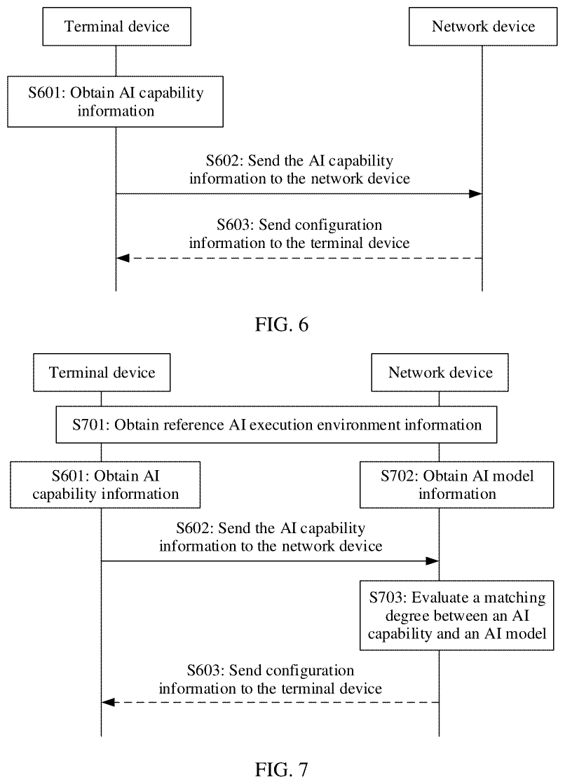

FIG. 7 is an example of a flowchart of a method in which a network device evaluates a matching degree between an AI capability and an AI model. As shown in FIG. 7, before a terminal device obtains AI capability information, optionally, in step S701, the terminal device and the network device obtains reference AI execution environment information.

Optionally, in step S601, in response to the terminal device not obtaining the similarity information (that is, the AI capability information) through local computing, the terminal device does not obtain the reference AI execution environment information. In other words, the terminal device does not perform step S701.

S702: After obtaining the reference AI execution environment information, the network device obtains AI model information, that is, AI model complexity information of M AI models, where M is a positive integer. For a specific implementation of obtaining, by the terminal device and the network device, the reference AI execution environment information in step S701, refer to the description in step S401 in the foregoing embodiment. For a specific implementation of obtaining, by the network device, the AI model complexity information of the M AI models in step S702, refer to descriptions in step S301 in the foregoing embodiment. Details are not described herein again.

Optionally, in step S702, in response to the network device not obtaining the AI model complexity information (that is, the AI model information) of the M AI models through local computing, the network device does not obtain the reference AI execution environment information. In other words, the network device does not perform step S701.

S703. The network device evaluates a matching degree between an AI capability of the terminal device and the AI model.

After step S602, that is, after the network device receives the AI capability information sent by the terminal device, the network device evaluates matching between the AI capability of the terminal device and the M AI models based on the AI capability information received in step S602 and the AI model information obtained in step S702.

As described above, optionally, the M AI models is prestored by the network device, or the M AI models is obtained by the network device from a third-party device, or the M AI models is generated by the network device. Alternatively, the network device does not care about specific structures or the like of the M AI models. The network device obtains the AI model complexity information from a third-party device or a network device server, or the network device is configured with the AI model complexity information or obtains the AI model information during delivery or software upgrade.

Similar to the foregoing embodiment, the network device obtains, through an evaluation of weighted average or optimal selection, expected completion time and/or expected power consumption of executing the M AI models in the terminal device. For example, in response to there being three reference AI execution environments, in step S602, the AI capability information sent by the terminal device to the network device includes: computing power ratios of the terminal device to the three reference AI execution environments, which are respectively r1, r2, and r3; and similarities of computing efficiency between the terminal device and the three reference AI execution environments, which are respectively s1, s2, and s3. In step S702, the network device obtains time of executing each of the M AI models in the three reference AI execution environments. A first AI model in the M AI models is used as an example. The network device obtains that time for executing the first AI model in the three reference AI execution environments is t1, t2, and t3 respectively. In step S703, in response to the weighted average method being used, the network device evaluates that the expected completion time of executing the first AI model by the terminal device is (t1*s1*r1+t2*s2*r2+t3*s3*r3)/(s1+s2+s3)+Δt or (t1*s1*r1+t2*s2*r2+t3*s3*r3)*(1+Δx)/(s1+s2+s3). In response to the optimal selection method being used, the network device evaluates that the expected completion time of executing the first AI model by the terminal device is t(i)*r(i)+Δt, or t(i)*r(i)*(1+Δx), where i=argmax(s(1), s(2), s(3)). For specific meanings of the parameters, refer to related descriptions in step S403 in the foregoing embodiment. Details are not described herein again. In addition, in response to the terminal device reporting a resource usage proportion status (an upper limit of resource proportion) to the network device, corresponding conversion is further performed. A conversion method is to divide the expected completion time obtained through computing in step S703 by the upper limit of resource proportion, to obtain converted expected completion time.

In addition, a method for evaluating, by the network device, the expected energy consumed in response to the terminal device executes the first AI model is also obtained by using the foregoing method. Details are not described herein again.

Based on the expected completion time and/or the expected power consumption that are obtained through the foregoing evaluation, and the information about the upper limit of time and/or the information about the upper limit of energy consumption that are sent by the terminal device and that are used to execute the AI model, the network device determines whether the M models match the AI capability of the terminal device. For example, in response to the expected completion time of the first AI model in the M models not exceeding a time budget of the terminal device, and/or the expected energy consumption not exceeding an energy consumption limit of the terminal device, the first AI model is determined to match the AI capability of the terminal device.

Further, as described in step S603, the network device sends configuration information to the terminal device.

In step S603, in response to the configuration information indicating at least one AI model, or the configuration information indicates a configuration parameter of at least one AI model, or the configuration information indicates a method for obtaining at least one AI model, before the network device sends the configuration information to the terminal device, the network device determines the at least one AI model based on the AI capability information. Specifically, in one case, the network device has only one AI model oriented to a current application. In response to the AI model matching the AI capability of the terminal device, the AI model is the AI model determined by the network device. In another case, the network device has a plurality of AI models oriented to a current application, and the network device selects at least one AI model from AI models that match the AI capability of the terminal device, and send or configure the AI model to the terminal device. A rule for selecting the AI model by the network device is shortest expected completion time, least expected energy consumption, a smallest expected resource proportion, or a random rule. In response to the network device determining the at least one AI model, the network device enables an AI mode.

In the embodiment shown in FIG. 7, for specific implementation processes of steps S601, S602, and S603, refer to related descriptions in the embodiment shown in FIG. 6. Details are not described herein again.

In the foregoing embodiment, the terminal device sends the similarity information between the terminal device and the reference AI execution environment as the AI capability information to the network device, so that the AI capability of the terminal device is accurately represented, and the network device obtains a more accurate evaluation result, and further determines whether to enable AI communication or deliver an AI model. This improves the accuracy and efficiency of the evaluation.

In the embodiment shown in FIG. 3, the network device sends the AI model information to the terminal device. Further, the terminal device evaluates the matching degree between the AI capability of the terminal device and the AI model. The complexity information of the M AI models sent by the network device is defined (or represented) by using time and/or energy consumption of executing the M AI models in the reference AI execution environment. The AI model complexity information is also represented in another manner. The following specifically describes another AI model information representation method and an evaluation process performed by the terminal device.

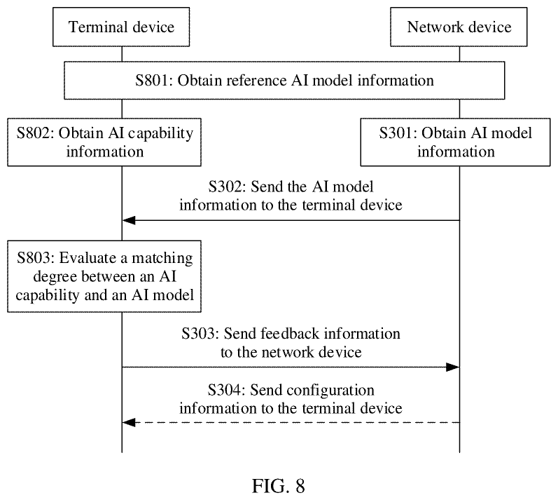

FIG. 8 is an example of a flowchart of another method in which a terminal device evaluates a matching degree between an AI capability and an AI model. As shown in FIG. 8, optionally, in step S801, the terminal device and a network device obtains reference AI model information. Optionally, the terminal device and the network device obtains the reference AI model information by referring to an AI model list. For example, the reference AI model list is standardized in advance or formulated offline, and is disclosed to the terminal device and the network device in advance. The reference AI model list includes names, numbers, or indexes of U reference AI models, and structure description parameters of the U reference AI models. The structure description parameters of the U reference AI models are alternatively provided by referring to a reference document or a link. Based on the reference AI model list, the network device and the terminal device uniformly understand the network structures of the U reference AI models. Optionally, a specific weight coefficient value (weight value) of each AI model is not defined, is predefined, or is a random number.

As shown in FIG. 3 and FIG. 8, in step S301, the network device obtains the AI model information. The AI model information indicates complexity information of each of M AI models.

Optionally, in step S301, in response to the network device not obtaining the AI model information through local computing, the network device does not obtain the reference AI model information. In other words, the network device does not perform step S801.

For example, the complexity information of each of the M AI models is represented by similarity data. For example, the AI model information indicates M groups of similarity information (or referred to as similarity data) corresponding to the M AI models. Each of the M groups of similarity information is similarity information between one of the M AI models and U1 reference AI models. The U1 reference AI models belong to the U reference AI models in the reference AI model list, where M and U are positive integers, and U1 is a positive integer not greater than U.

For example, in response to M=3 and U1=5, the AI model information includes three groups of similarity information (a first group of similarity information, a second group of similarity information, and a third group of similarity information) corresponding to three AI models (Q1, Q2, and Q3), where the first group of similarity information is similarity information between the AI model Q1 and five reference AI models, the second group of similarity information is similarity information between the AI model Q2 and the five reference AI models, the third group of similarity information is similarity information between the AI model Q3 and the five reference AI models.

Optionally, the similarity information between AI models is similarity information of a computing amount and/or energy consumption. For example, computing amount similarity information between AI models includes a computing amount ratio cr and a computing efficiency similarity cs.

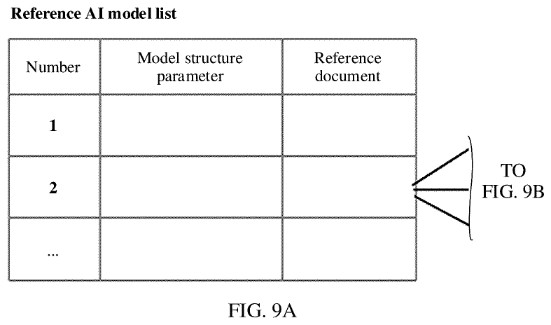

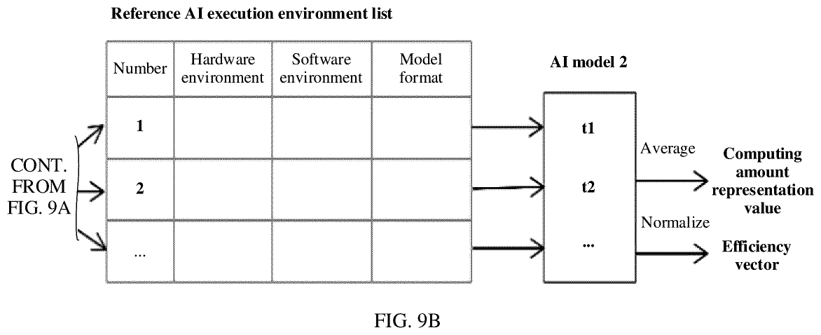

For a specific AI model, a computing amount characteristic of the AI model includes a computing amount representation value and a computing efficiency vector. As shown in FIG. 9A and FIG. 9B, a computing amount characteristic of an AI model 2 in the U reference AI models is used as an example. A computing method is as follows: First, a reference AI execution environment list is formulated, where the reference AI execution environment list includes V reference AI execution environments. The AI model 2 is sequentially executed (or trained and inferred) in V1 reference AI execution environments of the V reference AI execution environments, to obtain an execution time vector including V1 execution completion time corresponding to the AI model 2, where V is a positive integer, and V1 is a positive integer not greater than V. A computing amount representation value CA of the AI model 2 is obtained by averaging the vector, and a computing efficiency vector [symbol] of the computing amount of the AI model 2 is obtained by performing normalization processing on the vector. In this process, data processing is performed.

According to the foregoing method, computing amount characteristic information of the M AI models and the reference AI model is obtained. Further, the computing amount similarity information between the AI models is obtained by using the computing amount ratio cr and the computing efficiency similarity cs between the AI models. Specifically, a computing amount ratio between any two AI models is cr=CA1/CA2 and a computing efficiency similarity is cs=norm[sim( [symbol] )], where CA1 and CA2 are respectively computing amount representation values of the two AI models. [symbol] and [symbol] are computing efficiency vectors of the two AI models respectively. sim is a similarity function between two vectors, for example, a cosine similarity function, a Euclidean distance computing function, or a standardized Euclidean distance function. norm is a [0, 1] normalization computing function, that is, an input value of the normalization computing function is normalized to a range of [0, 1]. For example, in response to sim being used for cosine similarity computing and a result value range being [−1, 1], the normalization function

$$norm ( x ) = \frac{x + 1}{2} .$$

In this process, data processing is also performed.

In the foregoing method, a computing amount similarity between AI models is defined by using execution completion time of the AI models in a group of AI execution environments. Similarly, energy consumption of executing AI models in a group of AI execution environments is alternatively used to define an energy consumption characteristic of the AI model, to define an energy consumption similarity between the AI models. Details are not described herein again.

Step S802: The terminal device obtains AI capability information of the terminal device.

Optionally, the AI capability information of the terminal device is time and/or energy consumption of executing each of the U1 reference AI models in the terminal device.

Optionally, in step S802, in response to the terminal device does not obtain the AI capability information of the terminal device through local computing, the terminal device does not obtain the reference AI model information. In other words, the terminal device does not perform step S801.

In step S302, after the network device sends, to the terminal device, the AI model information represented by the AI model similarity information, in step S803 in the embodiment shown in FIG. 8, the terminal device evaluates, based on the AI model information sent by the network device and the AI capability information of the terminal device obtained in step S802, matching between the AI capability of the terminal device and the M AI models, that is, expected performance of executing the M AI models in the terminal device, for example, completion time and energy consumption.

For example, in response to U1=3, that is, there are three reference AI models, in step S802 the time of executing the three reference AI models in the terminal device is t1, t2, and t3 respectively. In step S302, the terminal device obtains similarity information between the M AI models and the three reference AI models. The AI model Q2 in the M AI models is used as an example. The terminal device obtains similarity data between the AI model Q2 and the three reference AI models. Computing amount ratios between the AI model Q2 and the three reference AI models are cr1, cr2, and cr3 respectively, and computing efficiency similarities between the AI model Q2 and the three reference AI models are cs1, cs2, and cs3 respectively. Further, in step S803, the terminal device obtains, by using the weighted average method and/or the optimal selection method, expected completion time of executing the AI model Q2 in the terminal device.

According to the foregoing method, the terminal device obtains the expected completion time of executing the M AI models in the terminal device. Similarly, the terminal device further obtains expected energy consumption of executing the M AI models in the terminal device.

Optionally, after the terminal device completes evaluation of the matching degree between the AI capability and the AI model, further, in S303, the terminal device sends the feedback information to the network device. In step S304, the network device sends the configuration information to the terminal device based on the feedback information sent by the terminal device. For specific implementations of steps S301, S302, S303, and S304, refer to related descriptions in the embodiment shown in FIG. 3. Details are not described again in at least one embodiment.

In this embodiment, complexity information of a to-be-delivered AI model is defined by using a similarity between the to-be-delivered AI model and the reference AI model, so that the terminal device evaluates matching between the to-be-delivered AI model and the AI capability of the terminal device more easily, efficiently, and accurately, and further determine whether to request to start the AI model or request to deliver the AI model. This improves accuracy and efficiency of evaluating, by the terminal device, the matching degree between the AI capability and the AI model.

In the embodiments shown in FIG. 4 and FIG. 7, the reference AI execution environment list is to be synchronized between the terminal device and the network device. In the embodiment shown in FIG. 8, the reference AI model list is to be synchronized between the terminal device and the network device, to perform a subsequent evaluation procedure. Considering that software and hardware that constitute the reference AI execution environment and typical reference AI models develop constantly, and the reference AI execution environment list and the reference AI model list also is to be gradually updated. For example, a new version is released every year. After the version is updated, the reference AI execution environment list and the reference AI model list are synchronized between the terminal device and the network device.

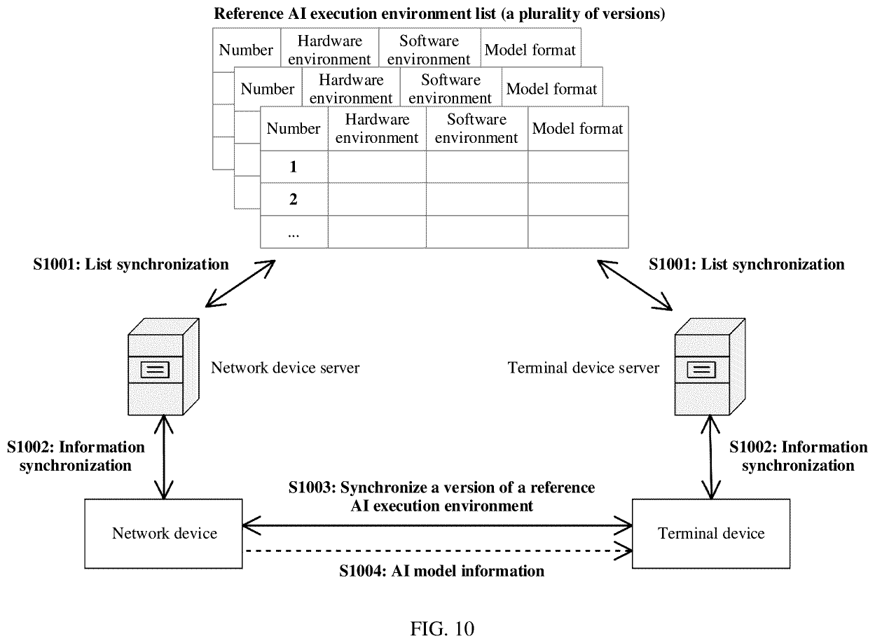

FIG. 10 shows a diagram of an architecture of a reference AI execution environment list and a maintenance and synchronization process of the reference AI execution environment list. As shown in FIG. 10, the architecture in this embodiment includes the reference AI execution environment list, servers corresponding to a terminal device and a network device respectively, and the terminal device and the network device.

The reference AI execution environment list includes a plurality of versions. For example, the reference AI execution environment list is disclosed to the public. The reference AI execution environment list is standardized by 3GPP, or is maintained by a vendor (for example, a network device vendor, a network device AI model provider, and a network operator).

The network device server is configured to synchronize the reference AI execution environment list, and the network device server is further configured to store execution representations of M AI models in each reference AI execution environment, that is, the AI model information described in the foregoing embodiments. The terminal device server is configured to synchronize the reference AI execution environment list, and the terminal device server is further configured to store similarity information between the terminal device and the reference AI execution environment in the reference AI execution environment list. Optionally, the network device server and the terminal device server do not coexist. For example, the terminal device server fails to be set and maintained. The similarity information between the terminal device and the reference AI execution environment in the reference AI execution environment list is built in in response to the terminal device being delivered: or being updated through software upgrade following an update of the reference AI execution environment list: or failing to be updated or upgraded. The network device is responsible for backward compatibility of the reference AI execution environment list.

For example, in response to the network device server and the terminal device server coexisting, at least one embodiment is shown in FIG. 10. The method includes but is not limited to the following steps.

S1001: The network device server performs list synchronization with the terminal device server.

In an implementation, the network device server and the terminal device server separately obtain information about the reference AI execution environment list. Further, the network device server obtains model complexity information of the M AI models through computing, and store the model complexity information in the network device server. The terminal device server obtains similarity information between the terminal device and the reference AI execution environment through computing, and store the similarity information in the terminal device server. In another implementation, the information about the reference AI execution environment list is alternatively obtained by a network device vendor and a terminal device vendor. In addition, the model complexity information (that is, the AI model information) of the M AI models and the similarity information (that is, AI capability information) between the terminal device and the reference AI execution environment are separately obtained offline based on the foregoing method, and then are separately stored in the network device server and the terminal device server.

S1002: The network device obtains the AI model information, that is, the model complexity information of the M AI models, from the network device server. The terminal device obtains the AI capability information from the terminal device server, that is, the similarity information between the terminal device and the reference AI execution environment.

S1003: The network device synchronizes a version of the reference AI execution environment list with the terminal device.

For example, after obtaining (or querying) a version that is of the reference AI execution environment and that is supported by the terminal device, the network device directly executes the version supported by the terminal device. Alternatively, after obtaining a version that is of the reference AI execution environment and that is supported by the terminal device, the network device updates the version from the network device server. The method is also applicable in response to no terminal device server existing.

Based on the aligned version of the reference AI execution environment, the network device and the terminal device perform the procedure shown in FIG. 3 or FIG. 6.

For example, S1004: The network device sends the AI model information to the terminal device. For a specific process and a subsequent process, refer to related descriptions in the embodiments shown in FIG. 3 and FIG. 4. Details are not described herein again.

For another example, S1004: The terminal device sends the AI capability information (not shown in FIG. 10) to the network device. For a specific process and a subsequent process, refer to related descriptions in the embodiments shown in FIG. 6 and FIG. 7. Details are not described herein again.

With reference to the embodiments shown in FIG. 3 and FIG. 4, the following describes an example of a procedure of maintaining and synchronizing a reference AI execution environment list.

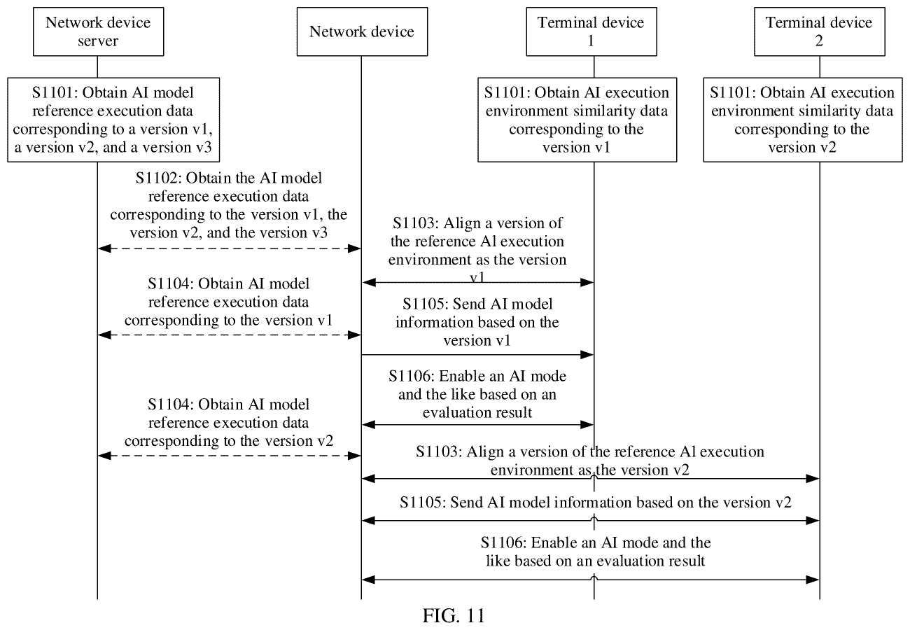

As shown in FIG. 11, two terminals (a terminal device 1 and a terminal device 2) are connected to a network device. Only the network device deploys and maintains a server, and the terminal devices do not deploy a server. The method includes, but is not limited to, the following steps.

S1101: The network device and the terminal device separately obtain AI model reference execution data and AI execution environment similarity data based on the reference AI execution environment list.

For example, the network device server obtains the AI model reference execution data. Considering that the reference AI execution environment list is continuously updated, and the network device server obtains AI model reference execution data corresponding to a plurality of versions of the reference AI execution environment, for example, AI model reference execution data corresponding to a version v1, a version v2, and a version v3, that is, time and/or energy consumption of executing an AI model in each reference AI execution environment in reference AI execution environment lists of the version v1, the version v2, and the version v3 respectively. At least one reference AI execution environment is different between any two of the reference AI execution environment lists of the version v1, the version v2, and the version v3. In other words, any two reference AI execution environment lists are different. For a process in which the network device server obtains the AI model reference execution data, refer to related descriptions in step S301.

The terminal device 1 and the terminal device 2 separately obtain the AI execution environment similarity data. Considering that a capability of the terminal device is limited, the terminal device obtains AI execution environment similarity data corresponding to only one version. For example, the terminal device 1 obtains AI execution environment similarity data corresponding to the version v1, and the terminal device 2 obtains AI execution environment similarity data corresponding to the version v2. Optionally, the AI execution environment similarity data corresponding to the version v1 is configured by the terminal device 1 before delivery, and the AI execution environment similarity data corresponding to the version v2 is configured by the terminal device 2 before delivery. For a process in which the terminal device obtains the AI execution environment similarity data, refer to related descriptions in step S402.

S1102: The network device obtains the AI model reference execution data of at least one version or all versions from the network device server.

For example, there are three versions v1, v2, and v3 of the reference AI execution environment. The network device obtains, from the network device server, the AI model reference execution data corresponding to the versions v1, v2, and v3. Optionally, in some other embodiments, the network device obtains AI model reference execution data of a corresponding version from the network device server (refer to step S1104). In this case, step S1102 is not performed.

S1103: The terminal device aligns the version of the reference AI execution environment list with the network device.

For example, the network device queries or obtains the version that is of the reference AI execution environment list and that is supported by the terminal device. As shown in FIG. 11, a version that is of the reference AI execution environment list and that is aligned between the network device and the terminal device 1 is the version v1, and a version that is of the reference AI execution environment list and that is aligned between the network device and the terminal device 2 is the version v2.

S1104: The network device obtains AI model reference execution data of the corresponding version from the network device server.

For example, as shown in FIG. 11, the network device obtains, from the network device server, the AI model reference execution data corresponding to the version 1, to perform subsequent configuration on the terminal device 1. The network device obtains, from the network device server, the AI model reference execution data corresponding to the version 2, to perform subsequent configuration on the terminal device 2.

In response to the network device obtaining the AI model reference execution data of the corresponding version in step S1102, step S1104 is not be performed.

S1105: The network device sends AI model information of the corresponding version to the terminal device.

For example, the network device sends the AI model information to the terminal device 1 based on the version v1, and the network device sends the AI model information to the terminal device 2 based on the version v2. For example, the AI model information includes M groups of AI model complexity information corresponding to M AI models. Each of the M groups of AI model complexity information is time and/or energy consumption of executing one of the M AI models in each of the N reference AI execution environments. For specific implementation of sending, by the network device, the AI model information to the terminal device, refer to related descriptions in step S302 in the embodiment shown in FIG. 3. Details are not described herein again.

Further, the terminal device evaluates, based on the AI model information sent by the network device and local AI execution environment similarity information, whether the AI model matches an AI capability of the terminal device, and determine a subsequent procedure based on an evaluation result. For example, in step S1106, the terminal device requests, based on the evaluation result, the network device to enable an AI model, or requests the network device to deliver at least one AI model. For a specific process and implementation of the evaluation of the terminal device, refer to related descriptions in the embodiment shown in FIG. 4. Details are not described herein again.

In the foregoing example, interaction between two terminal devices and a network device is used as an example for description. Optionally, in some other embodiments, there is more than two terminal devices.

The foregoing example is described by using an example in which there is no terminal device server. In at least one embodiment, a network device server and a terminal device server is alternatively deployed at the same time. This is not limited in at least one embodiment.

In FIG. 11, the embodiments shown in FIG. 3 and FIG. 4 are used as examples to describe a procedure of maintaining and synchronizing a reference AI execution environment list. In some other embodiments, maintenance and synchronization of a reference AI model list is alternatively performed by referring to a design idea shown in FIG. 11.

In the foregoing method, in response to a version of the reference AI execution environment list being continuously updated, versions of terminals are inconsistent, and there is no version update tracking path, synchronization of the version of the reference AI execution environment between the terminal device and the network device is implemented, and accuracy of the evaluation result is ensured.

According to the method provided in at least one embodiment, the network device sends the AI model information to the terminal device, so that the terminal device accurately and efficiently evaluates matching between the AI model and the AI capability of the terminal device. Alternatively, the terminal device sends the AI capability information of the terminal device to the network device, so that the network device accurately and efficiently evaluates matching between the AI model and the AI capability of the terminal device. In addition, in the method provided in at least one embodiment, the matching degree between the AI capability and the AI model is able to be evaluated between the terminal device and the network device without introducing an additional server device and an interaction protocol. In addition, according to the method provided in at least one embodiment, the versions of the reference AI execution environment list are aligned between the terminal device and the network device, to improve accuracy of the matching result.

To implement the functions in the foregoing embodiments, the network device and the terminal device include corresponding hardware structures and/or software modules for performing the functions. A person skilled in the art should be easily aware that, in at least one embodiment, the units and method steps in the examples described with reference to at least one embodiment is implemented by hardware or a combination of hardware and computer software. Whether a function is performed by using hardware or hardware driven by computer software depends on a particular application scenario and design constraint of the technical solutions.

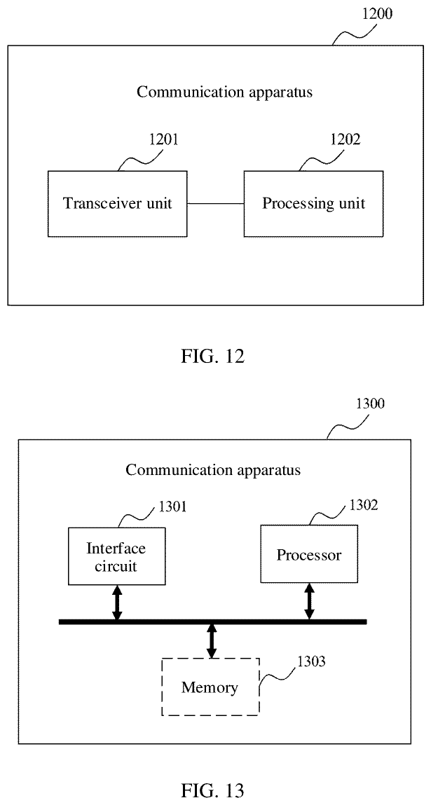

FIG. 12 and FIG. 13 are schematic diagrams of structures of communication apparatuses according to at least one embodiment. These communication apparatuses are configured to implement functions of the terminal device or the network device in the foregoing method embodiments. Therefore, beneficial effects of the foregoing method embodiments are able to be implemented. In at least one embodiment, the communication apparatus is a terminal device or a network device, or is a module (such as a chip) applied to a terminal device or a network device.

As shown in FIG. 12, the communication apparatus 1200 includes a transceiver unit 1201 and a processing unit 1202. The processing unit 1202 is configured to invoke the transceiver unit 1201 to receive information of another communication apparatus or send information to another communication apparatus. The transceiver unit 1201 further includes a receiving unit and a sending unit. The receiving unit is configured to receive information of another communication apparatus, and the sending unit is configured to send information to the another communication apparatus. The communication apparatus 1200 is configured to implement functions of the terminal device or the network device in the method embodiments shown in FIG. 3, FIG. 4, FIG. 6, and FIG. 7. The embodiment in FIG. 4 is based on the embodiment in FIG. 3, and the embodiment in FIG. 7 is based on the embodiment in FIG. 6. The following uses the embodiment in FIG. 3 and the embodiment in FIG. 6 as examples to describe operations separately performed by the transceiver unit 1201 and the processing unit 1202. For operations performed by the two units in other embodiments, refer to the method embodiments.

In response to the communication apparatus 1200 being configured to implement functions of the network device in the method embodiment shown in FIG. 3, the transceiver unit 1201 is configured to send AI model information to the terminal device, where the AI model information includes M groups of AI model complexity information corresponding to MAI models, each of the M groups of AI model complexity information is time and/or energy consumption of executing one of the M AI models in each of N reference AI execution environments, where M and N are positive integers. The processing unit 1202 is configured to obtain the AI model information. In response to the communication apparatus 1200 being configured to implement functions of the terminal device in the method embodiment shown in FIG. 3, the transceiver unit 1201 is configured to receive AI model information sent by the network device. The transceiver unit 1201 is further configured to send feedback information to the network device, where the feedback information requests the network device to enable an AI communication mode, or the feedback information includes an evaluation result of at least one of M AI models, or the feedback information requests to obtain at least one of the M AI models.

In response to the communication apparatus 1200 being configured to implement functions of the network device in the method embodiment shown in FIG. 6, the transceiver unit 1201 is configured to receive AI capability information sent by the terminal device, where the AI capability information includes a similarity between the terminal device and each of at least one reference AI execution environment. The transceiver unit 1201 is further configured to send configuration information to the terminal device based on the AI capability information, where the configuration information indicates the terminal device to enable an AI communication mode, or the configuration information indicates at least one AI model, or the configuration information indicates a configuration parameter of at least one AI model, or the configuration information indicates a method for obtaining at least one AI model. In response to the communication apparatus 1200 being configured to implement functions of the terminal device in the method embodiment shown in FIG. 6, the transceiver unit 1201 is configured to send AI capability information to the terminal device, where the AI capability information includes a similarity between the terminal device and each of at least one reference AI execution environment. The processing unit 1202 is configured to obtain the AI capability information.

For more detailed descriptions of the transceiver unit 1201 and the processing unit 1202, refer directly to related descriptions in the method embodiments shown in FIG. 3 and FIG. 6. Details are not described herein again.

Based on a same technical concept, as shown in FIG. 13, at least one embodiment further provides a communication apparatus 1300. The communication apparatus 1300 includes an interface circuit 1301 and a processor 1302. The interface circuit 1301 and the processor 1302 are coupled to each other. The interface circuit 1301 is a transceiver or an input/output interface. Optionally, the communication apparatus 1300 further includes a memory 1303, configured to store instructions executed by the processor 1302, store input data for running instructions by the processor 1302, or store data generated after the processor 1302 runs instructions.

In response to the communication apparatus 1300 being configured to implement the methods shown in FIG. 3, FIG. 4, FIG. 6, and FIG. 7, the processor 1302 is configured to implement functions of the processing unit 1202, and the interface circuit 1301 is configured to implement functions of the transceiver unit 1201.

In response to the communication apparatus being a chip used in a terminal device, the chip in the terminal device implements functions of the terminal device in the foregoing method embodiments. The chip in the terminal device receives information from another module (for example, a radio frequency module or an antenna) in the terminal device, where the information is sent by a network device to the terminal device. Alternatively, the chip in the terminal device sends information to another module (for example, a radio frequency module or an antenna) in the terminal device, where the information is sent by the terminal device to a network device.

The processor in eat least one embodiment is a central processing unit (central processing unit, CPU), or is another general-purpose processor, a digital signal processor (digital signal processor, DSP), an application-specific integrated circuit (application-specific integrated circuit, ASIC), a field programmable gate array (field programmable gate array, FPGA) or another programmable logic device, a transistor logic device, a hardware component, or any combination thereof. The general-purpose processor is a microprocessor or any conventional processor or the like.

Based on the foregoing embodiments, at least one embodiment provides a communication system. The communication system includes the terminal device, the network device, and the like in the foregoing embodiments.

At least one embodiment further provides a computer-readable storage medium. The computer-readable storage medium is configured to store a computer program. In response to the computer program being executed by a computer, the computer implements the downlink scheduling method provided in the foregoing method embodiments.

At least one embodiment further provides a computer program product. The computer program product is configured to store a computer program. In response to the computer program being executed by a computer, the computer implements the downlink scheduling method provided in the foregoing method embodiments.

At least one embodiment further provides a chip, including a processor. The processor is coupled to a memory, and is configured to invoke a program in the memory, so that the chip implements the downlink scheduling method provided in the foregoing method embodiments.

At least one embodiment further provides a chip. The chip is coupled to a memory, and the chip is configured to implement the downlink scheduling method provided in the foregoing method embodiments.

The method steps of at least one embodiment are implemented in a hardware manner, or is implemented in a manner of executing software instructions by the processor. The software instructions include a corresponding software module. The software module is stored in a random access memory (random access memory, RAM), a flash memory, a read-only memory (read-only memory, ROM), a programmable read-only memory (programmable ROM, PROM), an erasable programmable read-only memory (erasable PROM, EPROM), an electrically erasable programmable read-only memory (electrically EPROM, EEPROM), a register, a hard disk, a removable hard disk, a CD-ROM, or any other form of storage medium well-known in the art. For example, a storage medium is coupled to a processor, so that the processor reads information from the storage medium and writes information into the storage medium. Certainly, the storage medium is a component of the processor. The processor and the storage medium are disposed in an ASIC. In addition, the ASIC is located in a network device or a terminal device. Certainly, the processor and the storage medium alternatively exist as discrete components in a network device or a terminal device.

All or some of the foregoing embodiments are implemented by using software, hardware, firmware, or any combination thereof. In response to software being used to implement the embodiments, the embodiments are implemented entirely or partially in a form of a computer program product. The computer program product includes one or more computer programs and instructions. In response to the computer programs or instructions being loaded and executed on a computer, all or some of the processes or functions in at least one embodiment are executed. The computer is a general-purpose computer, a dedicated computer, a computer network, a network device, user equipment, or another programmable apparatus. The computer programs or instructions is stored in a computer-readable storage medium, or is transmitted from a computer-readable storage medium to another computer-readable storage medium. For example, the computer programs or instructions is transmitted from a website, computer, first device, or data center to another website, computer, first device, or data center in a wired or wireless manner. The computer-readable storage medium is any usable medium that is able to be accessed by a computer, or a data storage device, such as a first device or a data center, integrating one or more usable media. The usable medium is a magnetic medium, for example, a floppy disk, a hard disk drive, or a magnetic tape, is an optical medium, for example, a digital video disc (digital video disc, DVD), or is a semiconductor medium, for example, a solid-state drive (solid-state drive, SSD).

Apparently, a person skilled in the art is able to make various modifications and variations to at least one embodiment without departing from the scope of embodiments described herein. At least one embodiment is intended to cover these modifications and variations provided that the modifications and variations of embodiments described herein fall within the scope of protection defined by the following claims and their equivalent technologies.

1. An artificial intelligence (AI) communication method, comprising:
receiving, by a first apparatus, AI model information sent by a second apparatus, wherein the AI model information includes M groups of AI model complexity information corresponding to M AI models, each of the M groups of AI model complexity information is time and/or energy consumption of executing one of the M AI models in each of N reference AI execution environments, and M and N are positive integers; and
sending, by the first apparatus, feedback information to the second apparatus.

2. The method of claim 1, wherein the sending the feedback information includes sending feedback information that is usable to request the second apparatus to enable an AI communication mode; or
sending the feedback information that includes an evaluation result of at least one of the M AI models; or
sending the feedback information that is usable to request to obtain at least one of the M AI models.

3. The method of claim 1, wherein after sending, by the first apparatus, feedback information to the second apparatus, the method comprises:
receiving, by the first apparatus, configuration information sent by the second apparatus, wherein the configuration information is usable to indicate the first apparatus to enable the AI communication mode, or the configuration information is usable to indicate at least one of the M AI models, or the configuration information is usable to indicate a configuration parameter of at least one of the M AI models, or the configuration information is usable to indicate a method for obtaining at least one of the M AI models.

4. The method of claim 2, wherein the sending the feedback information that includes an evaluation result of at least one of the M AI models includes an evaluation result of a first AI model that is usable to indicate that the first AI model matches the first apparatus, or to indicate expected time and/or energy consumption of executing of the first AI model by the first apparatus.

5. The method of claim 1, wherein before receiving, by the first apparatus, AI model information sent by a second apparatus, the method comprises:
sending, by the first apparatus, request information to the second apparatus, wherein the request information is usable to request the second apparatus to send the AI model information to the first apparatus.

6. An artificial intelligence (AI) communication method, comprising:
obtaining, by a second apparatus, AI model information, wherein the AI model information includes M groups of AI model complexity information corresponding to M AI models, each of the M groups of AI model complexity information is time and/or energy consumption of executing one of the M AI models in each of N reference AI execution environments, and M and N are positive integers; and
sending, by the second apparatus, the AI model information to a first apparatus.

7. The method of claim 6, wherein after sending, by the second apparatus, the AI model information to a first apparatus, the method comprises: receiving, by the second apparatus, feedback information sent by the first apparatus, wherein the feedback information is usable to request the second apparatus to enable an AI communication mode, or the feedback information includes an evaluation result of at least one of the M AI models, or the feedback information is usable to request to obtain at least one of the M AI models.

8. The method of claim 7, wherein after receiving, by the second apparatus, feedback information sent by the first apparatus, the method comprises:
sending, by the second apparatus, configuration information to the first apparatus, wherein the configuration information is usable to indicate the first apparatus to enable the AI communication mode, or the configuration information is usable to indicate at least one of the M AI models, or the configuration information is usable to indicate a configuration parameter of at least one of the M AI models, or the configuration information is usable to indicate a method for obtaining at least one of the M AI models.

9. The method of claim 7, wherein the receiving the feedback information that includes an evaluation result of at least one of the M AI models includes receiving an evaluation result of a first AI model that is usable to indicate that the first AI model matches the first apparatus, or to indicate expected time and/or energy consumption of executing of the first AI model by the first apparatus.

10. The method of claim 6, wherein before the sending, by the second apparatus, the AI model information to the first apparatus, the method comprises:
receiving, by the second apparatus, request information sent by the first apparatus, wherein the request information is usable to request the second apparatus to send the AI model information to the first apparatus.

11. The method of claim 6, wherein the sending, by the second apparatus, the AI model information to the first apparatus includes:
periodically sending, by the second apparatus, the AI model information to the first apparatus: or
in response to the first apparatus accessing a network in which the second apparatus is located, sending, by the second apparatus, the AI model information to the first apparatus: or
in response to the first apparatus establishing a communication connection to the second apparatus, sending, by the second apparatus, the AI model information to the first apparatus; or
in response to structures or computing amounts of the M AI models changing, sending, by the second apparatus, the AI model information to the first apparatus.

12. The method of claim 7, wherein the receiving the feedback information includes receiving feedback information that is response information of the AI model information.

13. The method of claim 7, wherein the sending, by the second apparatus, the AI model information to a first apparatus includes sending AI model information corresponding to M AI models that includes a first AI model, the N reference AI execution environments include a first reference AI execution environment, time of executing the first AI model in the first reference AI execution environment is a first time value, a first time level, or a first time range, and energy consumption of executing the first AI model in the first reference AI execution environment is a first energy consumption value, a first energy consumption level, or a first energy consumption range.

14. A first apparatus, comprising: one or more processors and one or more memories, wherein
the one or more memories are coupled to the one or more processors, the one or more memories are configured to store computer instructions, wherein in response to the one or more processors executing the computer instructions cause the one or more processors to perform:
receiving artificial intelligence (AI) model information sent by a second apparatus, wherein the AI model information includes M groups of AI model complexity information corresponding to M AI models, each of the M groups of AI model complexity information is time and/or energy consumption of executing one of the M AI models in each of N reference AI execution environments, and M and N are positive integers; and
sending feedback information to the second apparatus.

15. The apparatus of claim 14, wherein the one or more processors are configured to send the feedback information that is usable to request the second apparatus to enable an AI communication mode: or
send the feedback information that includes an evaluation result of at least one of the M AI models: or
send the feedback information that is usable to request to obtain at least one of the MAI models.

16. The apparatus of claim 14, wherein after sending feedback information to the second apparatus, the one or more processors are configured to perform:
receiving configuration information sent by the second apparatus, wherein the configuration information is usable to indicate the first apparatus to enable the AI communication mode, or the configuration information is usable to indicate at least one of the M AI models, or the configuration information is usable to indicate a configuration parameter of at least one of the M AI models, or the configuration information is usable to indicate a method for obtaining at least one of the M AI models.

17. The apparatus of claim 15, wherein the at least one AI model includes a first AI model, and an evaluation result of the first AI model includes whether the first AI model matches the first apparatus, or an evaluation result of the first AI model includes expected time and/or energy consumption of executing of the first AI model by the first apparatus.

18. A second apparatus, comprising one or more processors and one or more memories, wherein
the one or more memories are coupled to the one or more processors, the one or more memories are configured to store computer instructions, wherein in response to the one or more processors executing the computer instructions cause the one or more processors to perform:
obtaining artificial intelligence (AI) model information, wherein the AI model information includes M groups of AI model complexity information corresponding to M AI models, each of the M groups of AI model complexity information is time and/or energy consumption of executing one of the M AI models in each of N reference AI execution environments, and M and N are positive integers; and
sending the AI model information to a first apparatus.

19. The apparatus of claim 18, wherein after sending the AI model information to a first apparatus, the one or more processors are configured to perform:
receiving feedback information sent by the first apparatus, wherein the feedback information is usable to request the second apparatus to enable an AI communication mode, or the feedback information includes an evaluation result of at least one of the M AI models, or the feedback information is usable to request to obtain at least one of the M AI models.

20. The apparatus of claim 18, wherein after receiving feedback information sent by the first apparatus, the one or more processors are configured is to perform:
sending configuration information to the first apparatus, wherein the configuration information is usable to indicate the first apparatus to enable the AI communication mode, or the configuration information is usable to indicate at least one of the M AI models, or the configuration information is usable to indicate a configuration parameter of at least one of the M AI models, or the configuration information is usable to indicate a method for obtaining at least one of the M AI models.
